(19) United States
(12) Patent Application Publication
(10) Pub. No.: US 2026/0065288 A1
(43) Pub. Date: Mar. 5, 2026

(54) Technologies for Resolving Disputed Transactions and Customer Service With Artificial Intelligence Agent-Based Systems

(71) Applicant: The PNC Financial Services Group, Inc., Pittsburgh, PA (US)

(72) Inventors: Lakhbir Lamba, Gibsonia, PA (US); Satyan Avatara, Landenberg, PA (US)

(21) Appl. No.: 19/311,283

(22) Filed: Aug. 27, 2025

Related U.S. Application Data
(60) Provisional application No. 63/688,018, filed on Aug. 28, 2024.
(60) Provisional application No. 63/733,522, filed on Dec. 13, 2024.

(51) Int. Cl. G06Q 30/016; H04L 9/40

(52) U.S. Cl. CPC G06Q 30/016; H04L 63/0428

(57) ABSTRACT

Technologies for resolving disputed transactions include a system with circuitry configured to receive a user interaction from a user interface channel, provide the user interaction with multiple topics and available actions for agent responsibility to a large language model, identify an action and parameters related to a dispute for a financial transaction in response to providing the user interaction to the large language model, execute the identified action with the parameters, and log data indictive of the user interaction, the identified action, the parameters, and any response. Other embodiments are also described and claimed.

### RELATED APPLICATIONS

This application claims the benefit of U.S. Provisional App. No. 63/733,522 filed Dec. 13, 2024 for “Technologies for Resolving Disputed Transactions and Customer Service with Artificial Intelligence Agent-Based Systems” and U.S. Provisional App. No. 63/688,018 filed Aug. 28, 2024 for “Technologies for Resolving Disputed Transactions,” which are each incorporated by reference in their entireties.

### BACKGROUND

In a modern economy, financial transactions are often conducted electronically through a payment network, such as a computerized credit card or debit payment network. A complex set of payment network dispute resolution rules and government regulations control how disputes concerning financial transactions should be resolved. However, applying the rules and regulations to a given dispute can be a resource intensive task, often requiring teams of personnel devoted to resolving such disputes. Further, in view of the fact that humans are tasked with resolving the disputes, human error and inconsistencies in application or interpretation of the rules and regulations may result in inconsistent resolutions of disputes.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for resolving disputed transactions;

FIG. 2 is a simplified block diagram of at least one embodiment of a compute device of the system of FIG. 1;

FIGS. 3-8 are flowcharts of at least one embodiment of a method for resolving disputed transactions that may be performed by the system of FIG. 1;

FIGS. 9-11 are flowcharts of at least one embodiment of a method for training one or more machine learning models to resolve disputed transactions that may be utilized by the system of FIG. 1;

FIGS. 12-14 are diagrams of user interfaces that may be produced by the system of FIG. 1;

FIG. 15 is a simplified block diagram of an agentic architecture for resolving disputed transactions that may be established by the system of FIG. 1;

FIG. 16 is flowchart of at least one embodiment of a method for agentic dispute resolution that may be performed by the system of FIG. 1;

FIGS. 17-20 are diagrams of user interfaces for a development environment that may be provided by the system of FIG. 1; and

FIG. 21 is a diagram of agent topics and actions that may be used with the agentic architecture for dispute resolution of FIG. 16.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

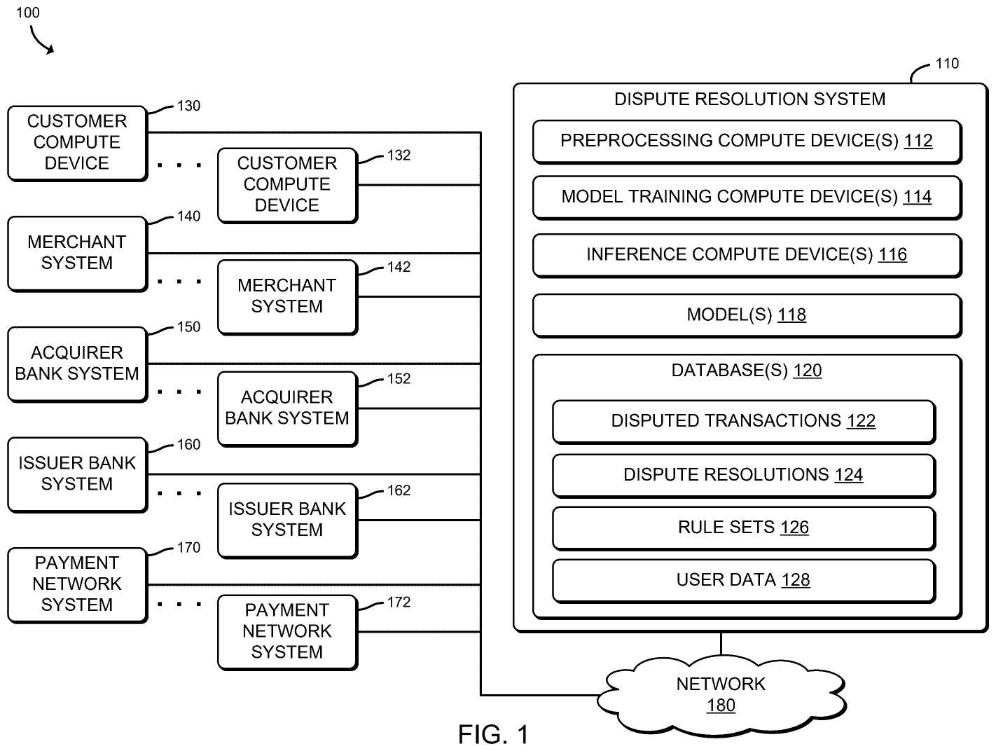

Referring now to FIG. 1, a system 100 for resolving disputed transactions includes a dispute resolution system 110 communicatively coupled to customer compute devices 130, 132, merchant systems 140, 142, acquirer bank (e.g., merchant bank) systems 150, 152, issuer bank systems 160, 162, and payment network systems 170, 172. In operation, the dispute resolution system 110 identifies and resolves disputes for financial transactions between customers (associated with the customer compute devices 130, 132) and merchants (e.g., associated with the merchant systems 140, 142). The financial transactions may be debit purchases or credit purchases and may be processed in accordance with rules of payment networks (e.g., associated with the payment network systems 170, 172), such as Visa or MasterCard. In particular, for disputed transactions, in which a customer identifies a financial transaction that the customer disagrees with on their account statement or other listing of recent transactions for their credit card or debit card (e.g., issued to the customer by an issuer bank, associated with the issuer bank systems 160, 162), sets of rules established by each of the payment networks describe, at least in part, how those disputes should be resolved.

Unlike typical systems, in which teams of human reviewers manually apply known circumstances of a financial transaction to the dispute resolution rules promulgated by the payment networks, the dispute resolution system 110 resolves the disputes with one or more artificial intelligence models 118 trained on past (e.g., historical) resolutions to disputes to financial transactions determined under the payment network rules. In particular, in the illustrative embodiment, the dispute resolution system 110 includes one or more inference compute devices 116 that execute one or more artificial intelligence (e.g., machine learning) models 118 to resolve the disputes. The one or more models 118 may be trained using one or more model training compute devices 114 (e.g., via supervised or unsupervised learning) using a database 120 of disputed transactions 122, dispute resolutions 124, and rule sets 126, which may include the payment network rules for resolving disputes. Further, the databases 120 may include user data 128 which may be embodied as any data indicative of characteristics of users of the dispute resolution system (e.g., customers), including demographic information, purchasing behavior, family members, residence location, and/or other data that may be utilized to determine whether a disputed transaction was fraudulently made (e.g., likely not made by the customer) or otherwise inform the resolution to a dispute. As described in more detail herein, the dispute resolution system 110 may also perform data preprocessing operations to reformat or supplement data pertaining to financial transactions before training the model(s) 118 or determining a resolution to a particular dispute. Additionally, in at least some embodiments, the model(s) 118 are further trained on government regulations pertaining to financial transactions, such as Regulation E (Electronic Fund Transfers, 12 CFR Part 1005) and/or Regulation Z (Truth in Lending, 12 CFR Part 1026), refund and/or exchange policies of particular merchants, and/or communication policies for keeping parties informed of the status of dispute resolutions. Accordingly, and unlike typical systems in which manual review is performed to resolve transactions, the system 110 improves consistency in dispute resolutions, reduces the opportunity for human error, and enables the dispute resolution process to be performed more efficiently (e.g., faster and with fewer personnel).

While a relatively small number of devices 110, 112, 114, 116, 120, 130, 132, 140, 142, 150, 152, 160, 162, 170, 172 are shown in FIG. 1 for simplicity and clarity, it should be understood that the number of devices, in practice, may range in the tens, hundreds, thousands, or more. Likewise, it should be understood that the devices 110, 112, 114, 116, 120, 130, 132, 140, 142, 150, 152, 160, 162, 170, 172 may be distributed differently or perform different roles than the configuration shown in FIG. 1. Further, though shown as separate devices, in some embodiments, the functionality of one or more of the devices 110, 112, 114, 116, 120, 130, 132, 140, 142, 150, 152, 160, 162, 170, 172 may be combined into fewer compute devices and/or distributed across more compute devices than those shown in FIG. 1.

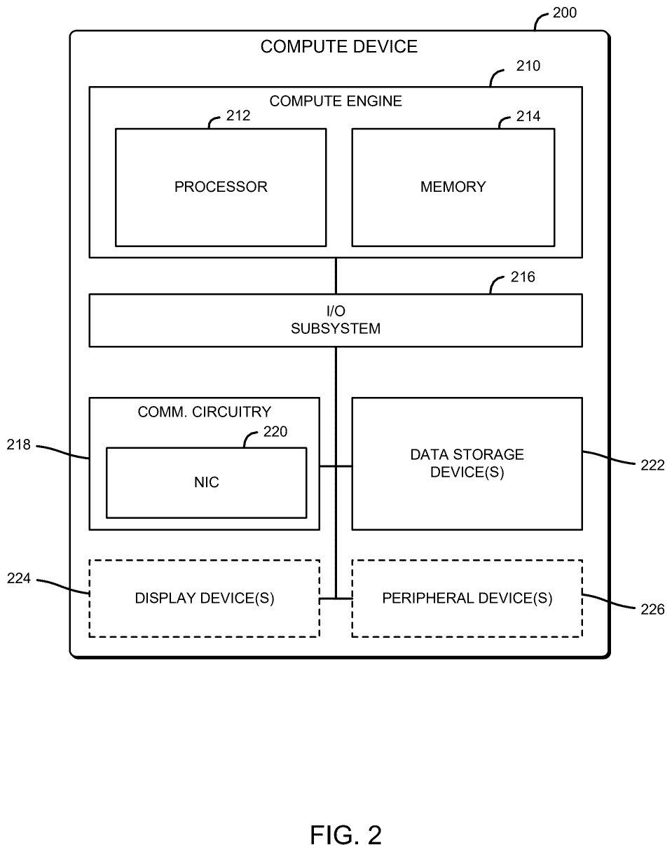

Referring now to FIG. 2, an illustrative embodiment of a compute device 200, representative of the devices 110, 112, 114, 116, 120, 130, 132, 140, 142, 150, 152, 160, 162, 170, 172, includes a compute engine 210, an input/output (I/O) subsystem 216, communication circuitry 218, and one or more data storage devices 222. In some embodiments, the compute device 200 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as at least one processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), one or more graphics processing units (GPUs), neural processing units (NPUs), and/or floating point units (FPUs), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the compute device 200 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as models, financial transaction data, applications, libraries, and drivers.

The compute engine 210 is communicatively coupled to other components of the compute device 200 via the I/O subsystem 216, which may be embodied as circuitry and/or components to facilitate input/output operations with the compute engine 210 (e.g., with the processor 212 and the main memory 214) and other components of the compute device 200. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the compute device 200, into the compute engine 210.

The communication circuitry 218 may be embodied as any communication circuit, device, or collection thereof, capable of enabling communications over a network between the compute device 200 and another device (e.g., a device 110, 112, 114, 116, 120, 130, 132, 140, 142, 150, 152, 160, 162, 170, 172, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the compute device 200 to connect with another compute device (e.g., a device 110, 112, 114, 116, 120, 130, 132, 140, 142, 150, 152, 160, 162, 170, 172, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the compute device 200 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the compute device 200 are housed in a single unit. However, in other embodiments, the components may be in separate housings, in separate racks of a data center, and/or spread across multiple data centers or other facilities. It should be appreciated that any of the devices 110, 112, 114, 116, 120, 130, 132, 140, 142, 150, 152, 160, 162, 170, 172 may include other components, sub-components, and devices commonly found in a computing device, which are not discussed above in reference to the compute device 200 and not discussed herein for clarity of the description.

In the illustrative embodiment, the devices 110, 112, 114, 116, 120, 130, 132, 140, 142, 150, 152, 160, 162, 170, 172, are in communication via a network 180, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

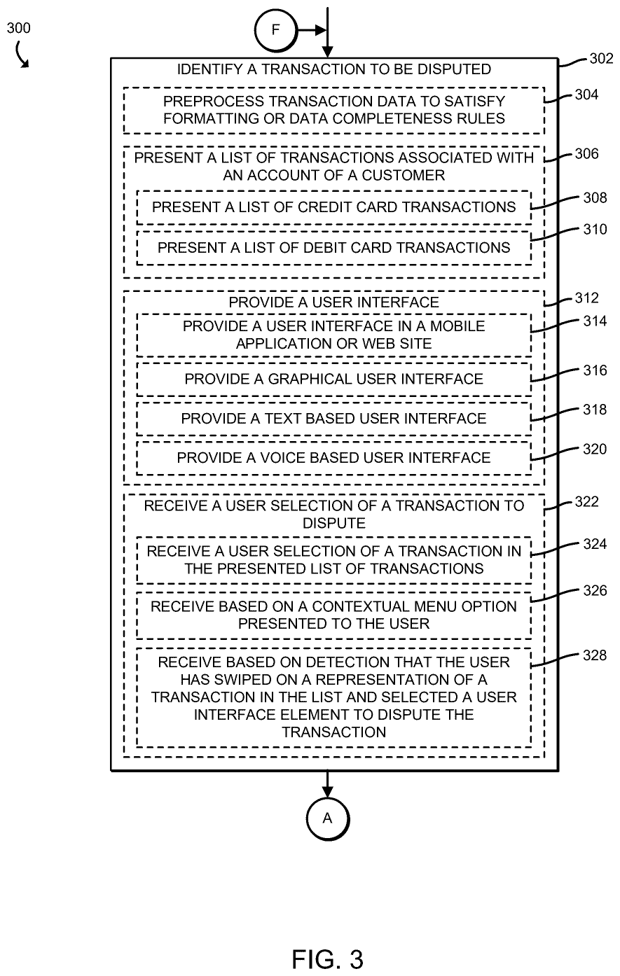

Referring now to FIG. 3, the dispute resolution system 110 may perform a method 300 for resolving financial transaction disputes. The method 300, in the illustrative embodiment, begins with block 302 in which the dispute resolution system 110 identifies a transaction to be disputed. In doing so, and as indicated in block 304, the dispute resolution system 110 may preprocess transaction data (e.g., data indicative of financial transactions, such as debit or credit transactions) to satisfy formatting or data completeness rules. For example, the dispute resolution system 110 may expand certain abbreviated terms (e.g., defined in a lookup table or other data structure in the memory 214) appearing in textual fields in the transaction data to other terms, convert text to a defined case (e.g., upper case), correct typographical errors in words, and/or eliminate duplicated spaces. In block 306, the dispute resolution system 110 may present a list of transactions (e.g., financial transactions) associated with an account of a customer. In doing so, the dispute resolution system 110 may present a list of credit card transactions (e.g., over a defined time period, such as a month), as indicated in block 308. Additionally or alternatively, the dispute resolution system 110 may present a list of debit card transactions, as indicated in block 310.

In the illustrative embodiment, the dispute resolution system 110 provides a user interface (e.g., by sending corresponding renderable code (e.g., hypertext markup language (HTML), JavaScript) and images (portable network graphics (PNG) files, joint photographic experts group (JPG) files, graphics interchange format (GIF) files, etc.) to a device of a user (e.g., a customer compute device 130, which may be embodied as a desktop compute device, notebook compute device, a tablet compute device, a smart phone, or other form factor), as indicated in block 312. In doing so, and as indicated in block 314, the dispute resolution system 110 may provide a user interface in a mobile application (e.g., executed natively on a compute device of a user (e.g., the customer compute device 130)) or web site (e.g., rendered in a web browser executed by the compute device of the user). The dispute resolution system 110 may provide a graphical user interface (e.g., an interface that includes one or more graphical elements, such as icons, buttons, and/or menus), as indicated in block 316. In some embodiments, the dispute resolution system 110 may provide a text based user interface (e.g., an interface that is primarily composed of text, such as text output to the user and an area to receive text from the user), as indicated in block 318. As indicated in block 320, the dispute resolution system 110 may provide a voice based user interface (e.g., based on speech synthesis and speech recognition), such as through an audio-only interface (e.g., via a telephonic connection to between the customer compute device 130 and the dispute resolution system 110).

As indicated in block 322, in identifying a transaction to be disputed, the dispute resolution system 110 may receive a user selection of the transaction to dispute. In doing so, and as indicated in block 324, the dispute resolution system 110 may receive a user selection of a transaction in the presented list of transactions (e.g., from block 306). Further, the dispute resolution system 110 may receive the selection of a transaction to dispute based on a contextual menu option presented to the user (e.g., a presented option to dispute a particular transaction shown in the list, such as after the user has selected the transaction), as indicated in block 326. As indicated in block 328, the dispute resolution system 110 may receive the user selection of the transaction to dispute based on a detection that the user has swiped (e.g., swiped a finger on a touch screen) on a representation of a transaction in the list and selected a user interface element (e.g., a button or icon) to dispute the corresponding transaction.

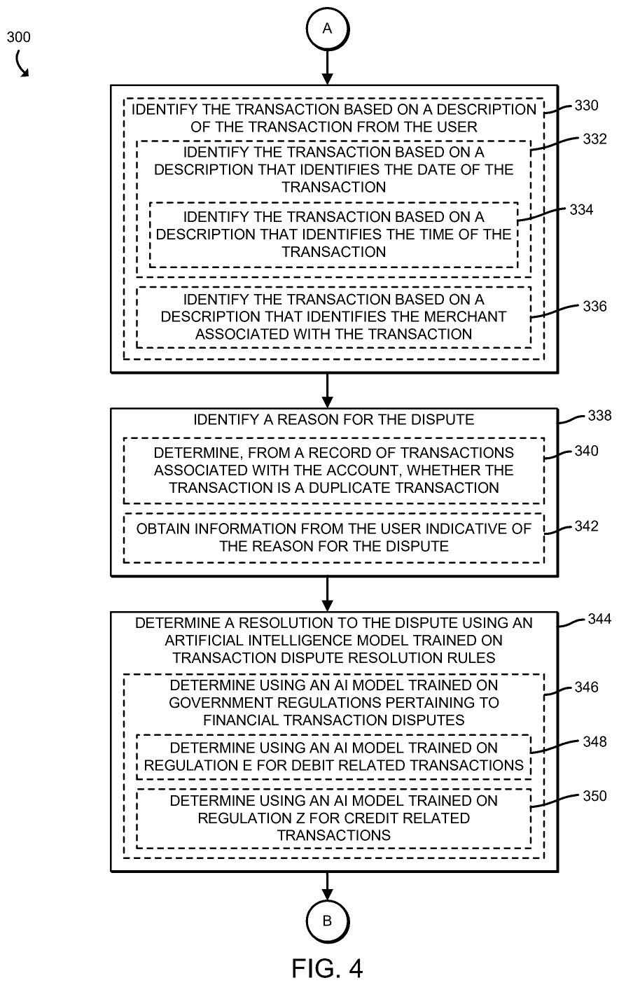

Referring now to FIG. 4, the dispute resolution system 110 may identify the transaction based on a description of the transaction from the user (e.g., provided in a text based or voice based interface), as indicated in block 330. In doing so, the dispute resolution system 110 may identify the transaction based on a description that identifies the date of the transaction, as indicated in block 332. In some embodiments, the dispute resolution system 110 may identify the transaction based on a description that additionally identifies the time of the transaction, as indicated in block 334. In block 336, the dispute resolution system 110 may additionally or alternatively identify the transaction based on a description that identifies the merchant associated with the transaction. The dispute resolution system 110 may perform the identification based on the provided description based on a similarity (e.g., a similarity score, such as a Levenshtein distance or a Jaccard index) between the information provided in the description(s) and corresponding fields (e.g., date, time, merchant, etc.) in the data set of transactions associated with a given account. As such, the dispute resolution system 110 may identify a corresponding transaction even when the information provided by the user (e.g., customer) is not an exact match.

In block 338, in the illustrative embodiment, the dispute resolution system 110 identifies a reason for the dispute. In doing so, the dispute resolution system 110 may determine, from a record of transactions associated with the account, whether the selected transaction is a duplicate transaction, as indicated in block 340. For example, as compared to another transaction, if the time and date are within a defined time period of each other (e.g., on the same date, within one hour of each other, etc.), are for the same amount of money, and are from the same merchant, the dispute resolution system 110 may determine that the selected transaction is a duplicate of the other transaction. The dispute resolution system 110 may obtain information from the user indicative of the reason for the dispute (e.g., if dispute resolution system 110 does not identify the selected transaction as a duplicate), as indicated in block 342. In doing so, the system may prompt the user to type, speak, or select, via the user interface, the reason from a set of predefined choices.

The dispute resolution system 110 may determine a resolution to the dispute using an artificial intelligence model (e.g., a model 118) trained on transaction dispute resolution rules, as indicated in block 344. In doing so, and as indicated in block 346, the dispute resolution system 110 may determine the resolution using an artificial intelligence model that is trained on government regulations pertaining to financial transaction disputes. For example, and as indicated in block 348, the dispute resolution system 110 may determine the resolution using an artificial intelligence model trained on Regulation E (Electronic Fund Transfers, 12 CFR Part 1005) for debit related transactions (e.g., in response to a determination that the transaction to be disputed is a debit transaction). Alternatively, the dispute resolution system 110 may determine the resolution using an artificial intelligence model trained on Regulation Z (Truth in Lending, 12 CFR Part 1026) for credit related transactions, as indicated in block 350.

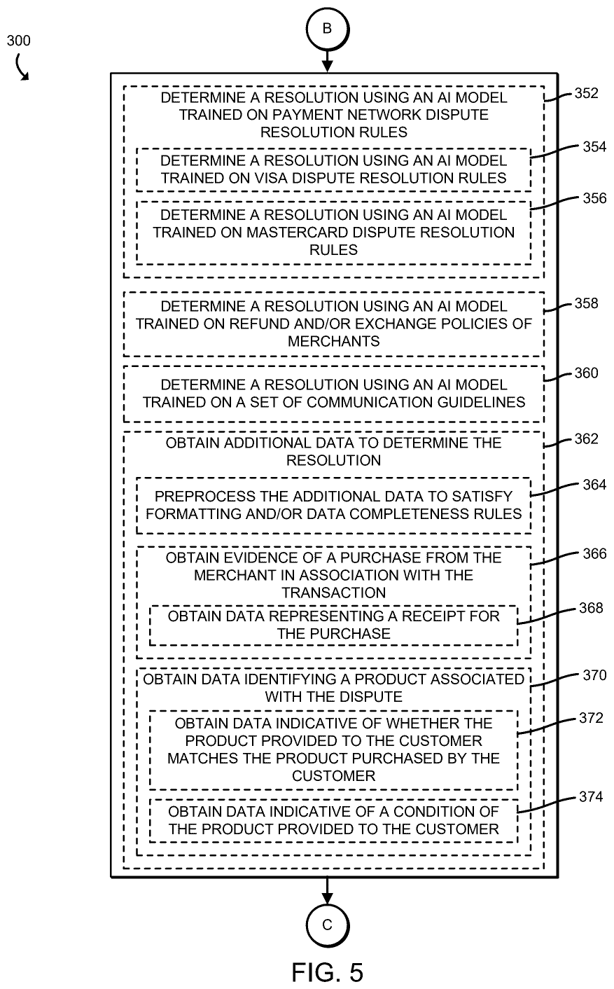

Referring now to FIG. 5, the dispute resolution system 110 may determine a resolution using an artificial intelligence model that has been trained on payment network dispute resolution rules, as indicated in block 352. For example, and as indicated in block 354, the dispute resolution system 110 may determine a resolution using an artificial intelligence model trained on dispute resolution rules of the Visa payment network (e.g., if the transaction pertains to a Visa credit card issued by the issuer bank 160). Alternatively, and as indicated in block 356, the dispute resolution system 110 may determine a resolution using an artificial intelligence model trained on dispute resolution rules of the MasterCard payment network (e.g., if the transaction was processed through the MasterCard payment network). In other embodiments, the dispute resolution system 110 may determine a resolution based on an artificial intelligence model trained on the rules of another payment network (e.g., if the transaction was processed through that payment network). As indicated in block 358, the dispute resolution system 110 may determine a resolution using an artificial intelligence model that is trained on refund and/or exchange policies of specific merchants (e.g., the merchant associated with the transaction). Those policies may be provided by the merchants via their websites, documents provided with products, or through other methods and may be interpreted (e.g., preprocessed) by the dispute resolution system 110 through natural language processing and utilized in training the model(s) 118. Accordingly, when other sources (e.g., the government regulation(s) and/or payment network dispute resolution rules) do not address a particular scenario associated with a transaction to be disputed, the dispute resolution system 110 may still determine a resolution based on the merchant's policy regarding a refund or product exchange. As indicated in block 360, the dispute resolution system 110 may determine a resolution using an artificial intelligence model that is further trained on a set of communication guidelines for keeping parties to the dispute informed of the status. Those guidelines, in at least some embodiments, may incorporate goals of striving for an immediate and effortless resolution (e.g., reducing compounding the problem by exceeding expectations for first contact resolution), reducing a feeling of waiting in the dark (e.g., by being transparent), providing a lifeboat to customers (e.g., providing help to the context of when and where people need it), providing a proactive and continuous conversation (e.g., personalizing interactions and delivering insights on a next course of action), and defining a problem from the customer's perspective (e.g., by using a customer's emotional and situational cues to proactively recognize and respond through action and acknowledgment).

As indicated in block 362, the dispute resolution system 110 may obtain additional data to determine the resolution. In doing so, the dispute resolution system 110 may preprocess the additional data to satisfy formatting and/or data completeness rules, as indicated in block 364. For example, the dispute resolution system 110 may perform image recognition operations to identify text or other objects represented in an image (e.g., of a product associated with a transaction, of a receipt associated with the transaction, etc.). As indicated in block 366, in obtaining additional data, the dispute resolution system 110 may obtain evidence of a purchase from the merchant associated with the transaction. For example, and as indicated in block 368, the dispute resolution system 110 may obtain data representing a receipt for the purchase (e.g., a picture taken by the customer and transmitted to the dispute resolution system 110 via the network 180, an electronic receipt sent to the customer compute device 130 (e.g., via email) from the merchant system 140 and transmitted by the customer compute device 130 to the dispute resolution system 110, etc.). As indicated in block 370, the dispute resolution system 110 may obtain data indicative of a product associated with the dispute. In doing so, and as indicated in block 372, the dispute resolution system 110 may obtain data indicative of whether the product provided to the customer matches the product purchased by the customer (e.g., by comparing an image or description of the product from a website of the merchant to an image of the product as received by the customer or by receiving a description from the customer (via the user interface) of how the received product differs from the product as advertised). As indicated in block 374, the dispute resolution system 110 may obtain data indicative of a condition of the product provided to the customer (e.g., by analyzing an image of the product to determine whether the product is visibly damaged, by receiving a description from the customer (via the user interface) of how the product is defective, etc.).

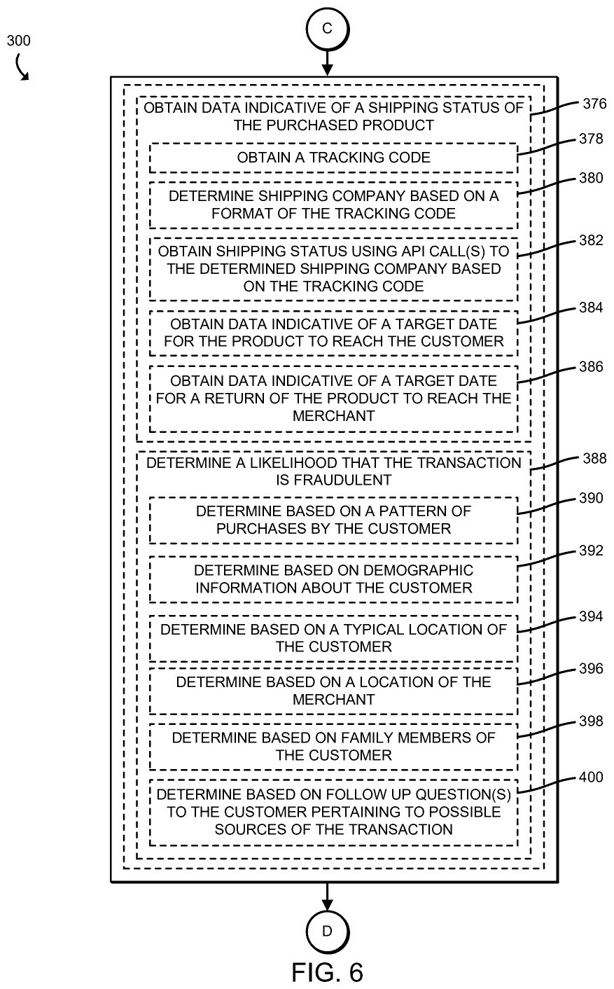

Referring now to FIG. 6, in continuing the method 300, the dispute resolution system 110 may obtain data indicative of a shipping status of the purchased product, as indicated in block 376. In doing so, and as indicated in block 378, the dispute resolution system 110 may obtain a tracking code, such as by receiving a tracking code from the customer via the user interface or by reading a tracking code printed on or otherwise included in the receipt discussed above with reference to block 368. The dispute resolution system 110 may determine a shipping company that has been assigned to transport the product (e.g., to the customer or back to the merchant, in the case of a product return) based on a format of the tracking code, as indicated in block 380. For example, the dispute resolution system 110 may determine that the tracking code is associated with one shipping company if the length of the tracking code satisfies a predefined length or that the tracking code is associated with another shipping company if the tracking code begins or ends with a particular predefined sequence of numbers and/or letters associated with the other shipping company. Having determined the shipping company, the dispute resolution system 110 may obtain the shipping status of the product using one or more application programming interface (API) calls to a computer system of the shipping company to obtain the status of the shipment, as indicated in block 382. Further, the dispute resolution system 110 may obtain data indicative of a target date for the product to reach the customer (e.g., based on the obtained shipping status), as indicated in block 384. Alternatively, such as in the case of a return of a product, the dispute resolution system 110 may obtain data indicative of a target date for the product to reach the merchant, as indicated in block 386.

In determining a resolution, the dispute resolution system 110 may determine a likelihood that the disputed transaction is fraudulent, as indicated in block 388. The dispute resolution system 110 may make the determination based on a pattern of purchases by the customer (e.g., based on an analysis of historical purchases of the customer indicated in the databases 120), as indicated in block 390. For example, if the product associated with the disputed transaction does not match a pattern of products associated with purchases by the customer (e.g., purchases from a particular brand, purchases indicative of a particular preference or interest of the customer, etc.), the dispute resolution system 110 may increase a determined likelihood that the transaction is fraudulent. Additionally or alternatively, the dispute resolution system 110 may determine the likelihood based on demographic information about the customer, as indicated in block 392. For example, if the customer is a male and the transaction relates to a purchase of women's clothing, the dispute resolution system 110 may increase the determined likelihood that the transaction is fraudulent. The dispute resolution system 110 may also determine the likelihood that the transaction is fraudulent based on a typical (e.g., usual) location of the customer, such as the customer's residence or work place, as indicated in block 394.

The dispute resolution system 110 may further determine the likelihood based on the location of the merchant associated with the transaction, as indicated in block 396. For example, the dispute resolution system 110 may increase the determined likelihood that the transaction is fraudulent if the distance between merchant location and the typical location of the customer is greater than a defined distance. The dispute resolution system 110 may also determine the likelihood that the transaction is fraudulent based on known family members of the customer (e.g., as defined in the databases 120, such as in the user data 128 and/or based on prompting the customer for such information), as indicated in block 398. For example, while the customer may not have purchased a product, a member of the customer's family may have obtained the customer's credit or debit card and made a purchase from the merchant. As indicated in block 400, the dispute resolution system 110 may also determine the likelihood that the transaction is fraudulent based on one or more follow up questions to the customer pertaining to possible sources of the transaction. For example, the dispute resolution system 110 may suggest an alternative name of the merchant (e.g., other than the name displayed on the record of the transaction) that may have been displayed to the customer at the time of purchase, which may cause the customer to confirm that the purchase was legitimately made.

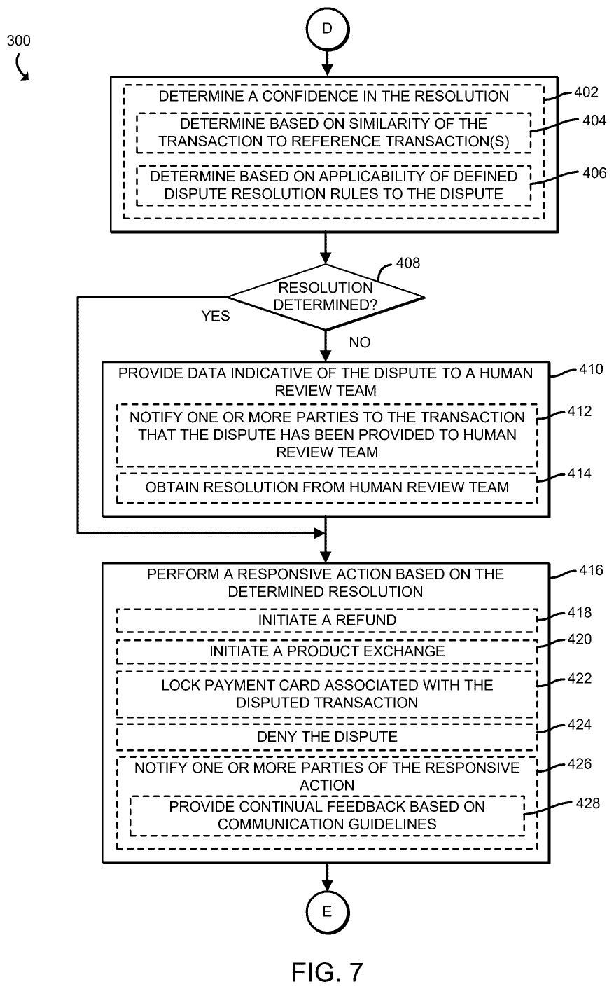

Referring now to FIG. 7, the dispute resolution system 110 may determine a confidence in the resolution, as indicated in block 402. In doing so, and as indicated in block 404, the dispute resolution system 110 may determine the confidence based on a similarity of the transaction in dispute to one or more reference transactions (e.g., from historical disputed transactions 122 and historical dispute resolutions 124, which may be used as training data for the model(s) 118). The dispute resolution system 110 may also determine the confidence based on an applicability of defined dispute resolution rules (e.g., the payment network dispute resolution rules, the government regulations, the merchant refund and/or exchange policies) to the situation associated with the disputed transaction, as indicated in block 406. For example, the dispute resolution system 110 may reduce the confidence in the resolution if the rules do not directly address the situation associated with the dispute and/or no historical dispute and resolution matches the situation associated with the presently disputed transaction. If the confidence in the determined resolution does not satisfy a defined threshold (e.g., 90%), the dispute resolution system 110 may designate the resolution as unsatisfactory or otherwise not conclusively determined.

In block 408, the dispute resolution system 110 determines a subsequent course of action based on whether a resolution has been determined (e.g., with sufficient confidence). If not, the method 300, in the illustrative embodiment, advances to block 410 in which the dispute resolution system 110 provides data indicative of the dispute (e.g., a record of the transaction, the reason for the dispute, and any additional data obtained in block 362) to a human review team (e.g., to verify the resolution produced by the dispute resolution system 110). In doing so, and as indicated in block 412, the dispute resolution system 110 may notify one or more parties (e.g., the customer using the customer compute device 130, the merchant associated with the merchant system 140, the acquirer bank associated with the acquirer bank system 150, the issuer bank associated with the issuer system 160, etc.) to the transaction that the dispute has been provided to a human review team. As indicated in block 414, the dispute resolution system 110 may obtain a resolution (e.g., confirmation of the resolution produced by the dispute resolution system 110 or a different resolution) from the human review team. Subsequently, or if in block 408 the dispute resolution system 110 determines that a resolution has been determined, the method 300 advances to block 416.

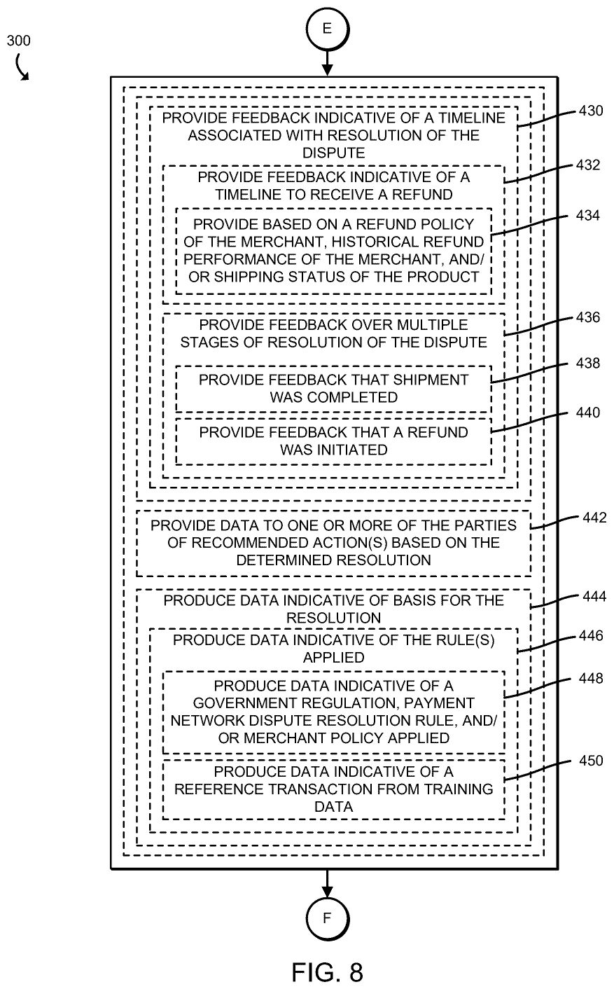

Having obtained a resolution to the dispute, the dispute resolution system 110, in block 416, performs a responsive action based on the determined resolution. In doing so, the dispute resolution system 110 may initiate a refund, as indicated in block 418. Alternatively, the dispute resolution system 110 may initiate a product exchange (e.g., by which the customer returns the as-received product for a replacement product), as indicated in block 420. The dispute resolution system 110 may lock a payment card associated with the disputed transaction, such as if the dispute resolution system 110 determines that the transaction was fraudulent (e.g., based on the determination in block 388), as indicated in block 422. In some cases, as indicated in block 424, the dispute resolution system 110 may deny the dispute, according to the applicable rules and/or regulations (e.g., payment network dispute resolution rules, government regulations, and/or merchant policies), as represented in training data used by the model(s) 118. Pursuant to the communication policies, on which the model(s) 118 may be trained, the dispute resolution system 110 notifies one or more parties to the transaction of the responsive action (e.g. via a corresponding user interface), as indicated in block 426. In doing so, the dispute resolution system 110 may provide continual feedback based on the communication guidelines, as indicated in block 428. For example, as and indicated in block 430 of FIG. 8, the dispute resolution system 110 may provide feedback indicative of a timeline associated with resolution of the dispute.

In providing feedback indicative of a timeline for resolution of the dispute, the dispute resolution system 110 may provide feedback indicative of a timeline to receive a refund (e.g., from a product return), as indicated in block 432 of FIG. 8. The dispute resolution system 110 may provide the feedback based on a refund policy of the merchant, historical refund performance of the merchant (e.g., the merchant's historical average time period for providing refunds after product has been delivered back to the merchant), and/or shipping status of the product (e.g., whether the product has arrived back at the merchant or a number of days until the product arrives back at the merchant), as indicated in block 434. In the illustrative embodiment, when implementation of the responsive action is not immediately completed, the dispute resolution system 110 may provide feedback over multiple stages of resolution of the dispute, as indicated in block 436. For example, and as indicated in block 438, the dispute resolution system 110 may provide feedback indicating that shipment of the product was completed (e.g., that the product returned by the customer arrived at the merchant or that an exchange product shipped by the merchant arrived at a location specified by the customer). As another example, the dispute resolution system 110 may provide feedback that a refund was initiated by the merchant (e.g., that the merchant submitted the refund to the customer's account), as indicated in block 440.

The dispute resolution system 110 may provide data to one or more of the parties of recommended actions to take, based on the determined resolution, as indicated in block 442. For example, the dispute resolution system 110 may provide, through the user interface, an address of where to send a product for a refund or exchange. Further, the dispute resolution system 110 may provide a shipping label or informational document (e.g., to be printed by the customer) to be included with the return to expedite processing of the refund or exchange. To assist with explainability and auditing of the resolutions determined by the dispute resolution system 110, the dispute resolution system 110, in the illustrative embodiment, produces data (e.g., in a log file, in a user interface presented to a party to the transaction, etc.) indicative of the basis for the determined resolution to the dispute, as indicated in block 444. In doing so, and as indicated in blocks 446, 448 the dispute resolution system 110 may produce data indicative of the rule(s) applied (e.g., the payment network dispute resolution rule(s), the government regulations, and/or the merchant policy) relied on in reaching the resolution to the dispute. For example, the dispute resolution system 110 may cite the rule and quote pertinent language from the rule that applies to the situation associated with the dispute. As indicated in block 450, the dispute resolution system 110 may additionally produce data indicative of a reference transaction used as training data (e.g., from the database 120) and upon which the dispute resolution system 110 based the present resolution. Subsequently, the method 300 may loop back to block 302 of FIG. 3 to identify another transaction to be disputed.

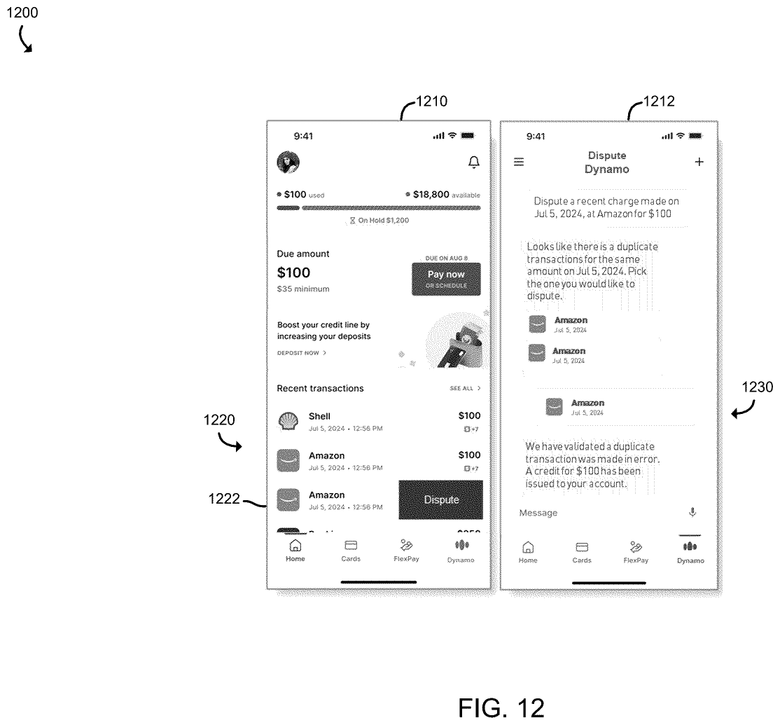

Referring briefly to FIG. 12, in set of interactions 1200, the system 100 may produce a user interface 1210 (e.g., displayed on the customer compute device 130) that includes a list 1220 of financial transactions associated with an account (e.g., a credit card account) of a customer. In the list 1220, the customer has swiped left on a representation of the transaction 1222 and, in response, a user interface element to dispute the transaction 1222 is displayed. In response to selection of the user interface element, the system 100 produces the user interface 1212, which includes a primarily text-based interface 1230 to enable the customer to communicate with the dispute resolution system 110 (e.g., with a model 118) to confirm the reason for the dispute (e.g., that the transaction 1222 is a duplicate of another transaction in the list 1220) and to obtain the status of the resolution (e.g., that a credit for $100 has been issued to the account of the customer).

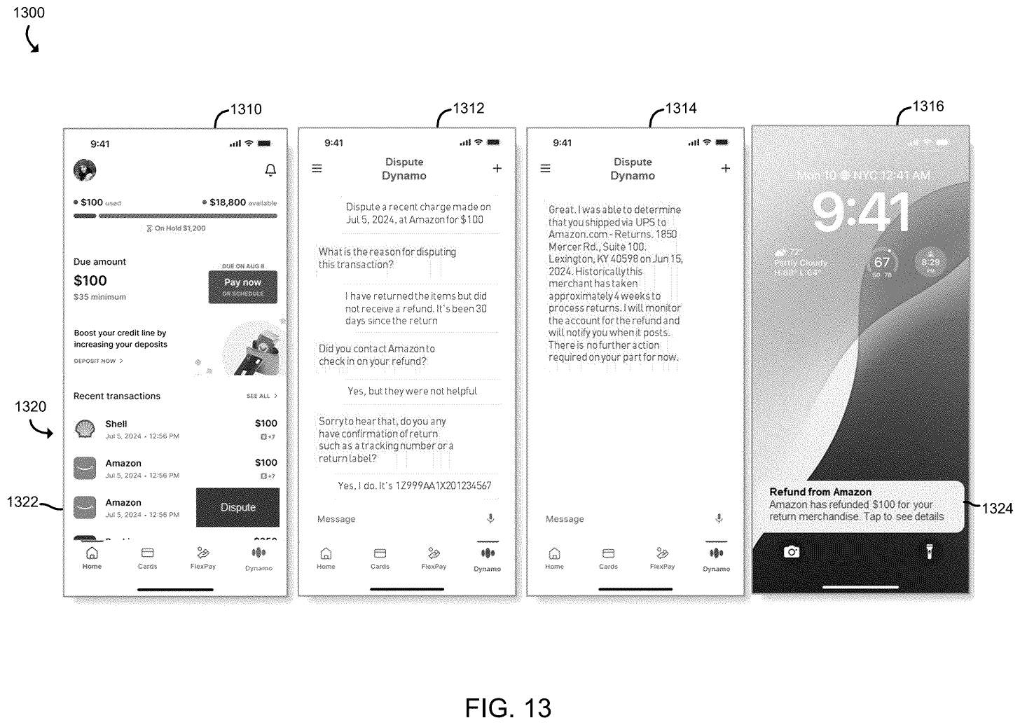

Similarly, FIG. 13 represents a set of interactions 1300 in which the system 100 produces a user interface 1310 with a list of transactions 1320 and a selected transaction 1322 to dispute. In the user interfaces 1312, 1314, 1316, the dispute resolution system 110 prompts the user to describe the reason for the transaction, obtains a tracking number from the customer for a return of the product, determines the status of the shipment based on the tracking number, combines the shipment status with a historical performance of the merchant in providing refunds (e.g., four weeks after receiving returned product), and at a later time, produces a notification 1324 on a home screen of the customer compute device 130 (e.g., in the user interface 1316) indicating that the merchant has issued a refunded to the customer's account.

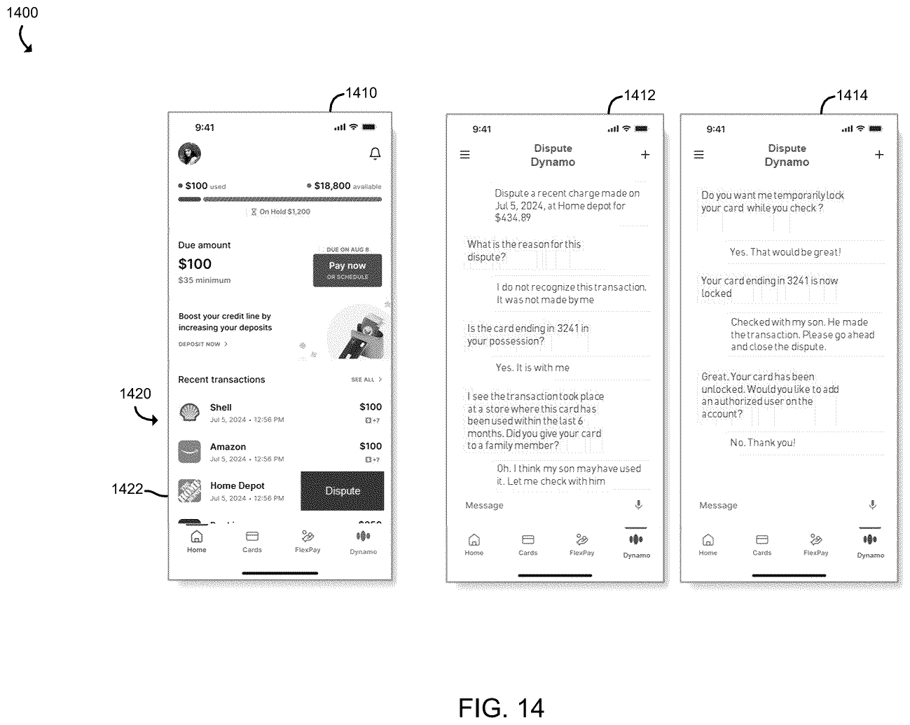

Additionally, FIG. 14 represents a set of interactions 1400 in which the customer disputes a transaction 1422 in a list 1420 shown on a user interface 1410. In response, in the user interfaces 1412, 1414, the dispute resolution system 110 prompts the consumer for the reason for the dispute, determines that the payment card has been used with the corresponding merchant within a predefined time period (i.e., six months), determines that the consumer has a family, and suggests that a family member may have used the payment card to make a purchase at the merchant. Further, the dispute resolution system 110 offers to lock the payment card while the customer investigates the possible source of the transaction, locks the payment card in response to the customer's confirmation to do so, and unlocks the payment card after the customer responds that a family member indeed made the purchase.

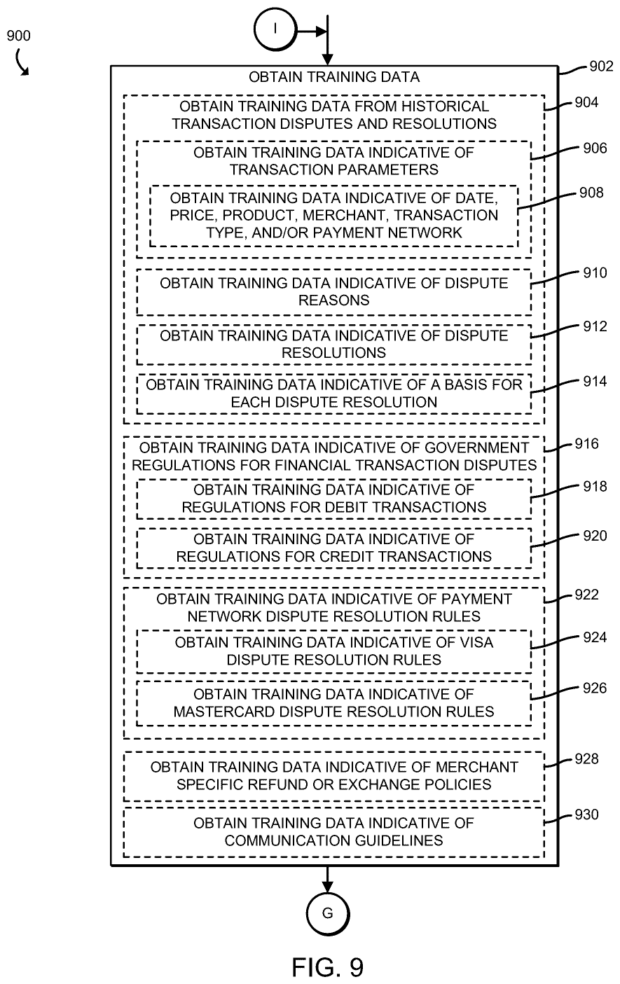

Referring now to FIG. 9, the dispute resolution system 110 may perform a method 900 for training one or more machine learning models (e.g., the models 118) to resolve disputed transactions. In at least some embodiments, one or more of the model training compute devices 114 of the dispute resolution system 110 may perform all or a portion of the operations of the method 900. In the illustrative embodiment, the method 900 begins with block 902 in which the dispute resolution system 110 obtains training data. In doing so, the dispute resolution system 110, in the illustrative embodiment, obtains training data from historical transaction disputes and resolutions of those disputes, as indicated in block 904. The dispute resolution system 110 may obtain that data from the data sets of disputed transactions 122 and dispute resolutions 124 in the databases 120 in FIG. 1, which may be populated by one or more systems of record of a financial institution (e.g., a bank). In doing so, the dispute resolution system 110 obtains training data that is indicative of transaction parameters, which may include the date of each transaction, the price (e.g., monetary amount) of each transaction, the product sold in the transaction, the merchant, the type of transaction (e.g., debit or credit), and the payment network through which the transaction was processed (e.g., Visa, MasterCard, or other payment network), as indicated in blocks 906, 908.

Further, in obtaining training data, the dispute resolution system 110, in the illustrative embodiment, obtains data indicative of the reasons for the disputes, as indicated in block 910. The training data also includes the resolutions to the disputes and the basis (e.g., in the payment network rules, in government regulations, and/or a merchant's refund or exchange policy) for the resolution to each of the disputes, as indicated in blocks 912, 914. As indicated in block 916, the dispute resolution system 110, in the illustrative embodiment, obtains training data indicative of government regulations for financial transaction disputes. In doing so, the dispute resolution system 110 may obtain training data indicative of government regulations for debit transactions (e.g., Regulation E, Electronic Fund Transfers, 12 CFR Part 1005), as indicated in block 918. The dispute resolution system 110, in the illustrative embodiment, also obtains training data indicative of government regulations for credit transactions (e.g., Regulation Z, Truth in Lending, 12 CFR Part 1026), as indicated in block 920. Further, and as indicated in block 922, the dispute resolution system 110 obtains training data indicative of payment network dispute resolution rules. In doing so, the dispute resolution system 110 may obtain dispute resolution rules for different payment networks, such as Visa and MasterCard, as indicated in blocks 924, 926.

Additionally, in at least some embodiments, the dispute resolution system 110 obtains training data indicative of merchant specific policies for refunds and/or exchanges (e.g., from the merchant systems 140, 142 via one or more API calls, by reading the policies from the websites of the merchants, or from other sources associated with the merchants), as indicated in block 928. The dispute resolution system 110 may also obtain training data indicative of communication guidelines (e.g., of an organization that operates the system 110). Those guidelines may represent goals including striving for an immediate and effortless resolution (e.g., reducing compounding the problem by exceeding expectation for first contact resolution), reducing a feeling of waiting in the dark (e.g., by being transparent), providing a lifeboat to customers (e.g., providing help to the context of when and where people need it), providing a proactive and continuous conversation (e.g., personalizing interactions and delivering insights on a next course of action), and defining a problem from the customer's perspective (e.g., by using a customer's emotional and situational cues to proactively recognize and respond through action and acknowledgment), as indicated in block 930.

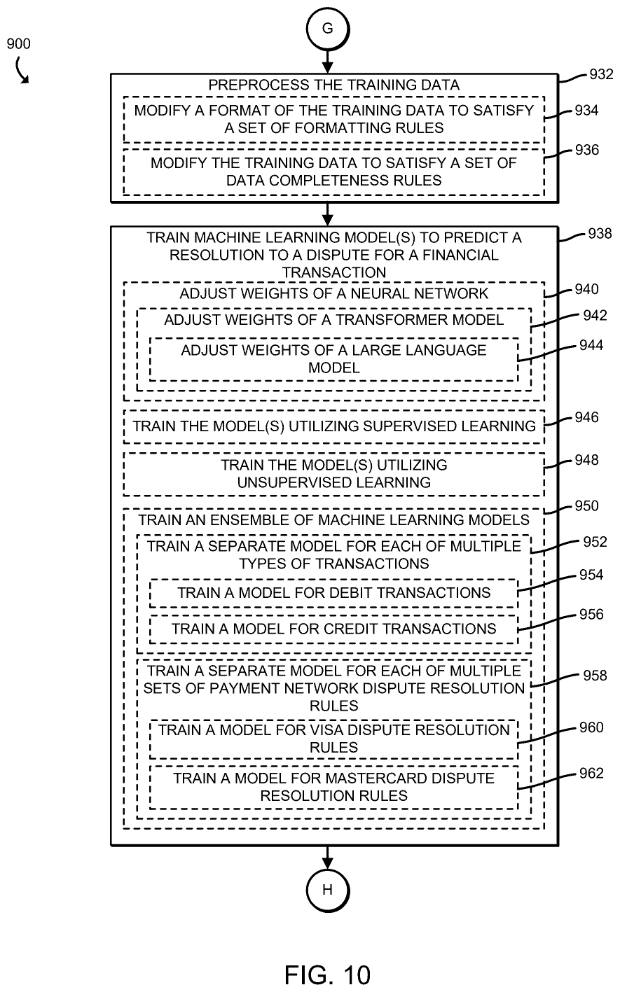

Referring now to FIG. 10, the dispute resolution system 110 may preprocess the training data, as indicated in block 932. In doing so, the dispute resolution system 110 may modify a format of the training data to satisfy a set of formatting rules, as indicated in block 934 and/or data completeness rules, as indicated in block 936. For example, preprocessing may include expanding certain abbreviated terms defined in a lookup table or other data structure (e.g., in the memory 214) appearing in training data, correcting typographical errors in words, and/or eliminating duplicated spaces. In at least some embodiments, the preprocessing may include performing object recognition, optical character recognition, natural language processing, or related techniques to covert images of documents to parseable text, as needed, and parsing the text into an intermediate form (e.g., syntax trees and/or graphs) suitable for use in training an artificial intelligence model.

Continuing the method 900, the dispute resolution system 110 trains the machine learning model(s) 118 to predict (e.g., determine, infer, etc.) a resolution to a dispute for a financial transaction, as indicated in block 938. In doing so, the dispute resolution system 110 may adjust (e.g., iteratively, to reduce error in predictions), weights of a neural network (e.g., one or more of the models 118 may be structured as a neural network), as indicated in block 940. More specifically, in at least some embodiments, the dispute resolution system 110 may adjust weights of one or more transformer models (e.g., a neural network architecture with multiple layers, including attention layers, feed-forward layers, and normalization layers, that processes sequential data, such as sentences or time-series data, to convert an input sequence into an output sequence and to track relationships in the sequential data), as indicated in block 942. That is, one or more of the models 118 may be a transformer model. Further, in the illustrative embodiment, the dispute resolution system 110 adjusts weights of a large language model (LLM) (e.g., a combination of transformer models that together are trained to recognize, summarize, translate, predict, and generate content, including text), as indicated in block 944. In at least some embodiments, the models 118 may be foundational models that are initially trained on a relatively large set of generalized data to establish relationships between words before being further trained on the training data obtained in block 902.

In some embodiments, the dispute resolution system 110 may train the models 118 utilizing supervised learning (e.g., utilizing labeled data sets to adjust weights in the models 118 to reduce error according to a loss function), as indicated in block 946. In other embodiments, the dispute resolution system 110 may train the models 118 at least partially utilizing unsupervised learning (e.g., utilizing unlabeled data sets to identify clusters and other relationships in the data), as indicated in block 948. The dispute resolution system 110 may train an ensemble of machine learning models 118, as indicated in block 950. In doing so, the dispute resolution system 110 may train a separate model for each of multiple types of transactions, as indicated in block 952. For example, the dispute resolution system 110 may train a model 118 for resolving disputes for debit transactions, as indicated in block 954 and may train another model 118 for resolving disputes for credit transactions, as indicated in block 956. Additionally or alternatively, the dispute resolution system 110 may train a separate model 118 for each of multiple sets of payment network dispute resolution rules, as indicated in block 958. In doing so, the dispute resolution system 110 may train a model 118 based on Visa dispute resolution rules, as indicated in block 960 and may train another model 118 based on MasterCard dispute resolution rules, as indicted in block 962. Further, and as indicated in block 964, the dispute resolution system 110 may train a separate model 118 for communicating with parties associated with a transaction based on a set of communication guidelines (e.g., the communication guidelines referenced in block 930). The dispute resolution system 110 may also train one or more separate models 118 on government regulations pertaining to financial transactions and/or on merchant policies regarding refunds and/or exchanges. In the illustrative embodiment, the training method 900 may operate continually, thereby enabling the models 118 to continually adapt to new rules, regulations, policies, and guidelines for transaction dispute resolution.

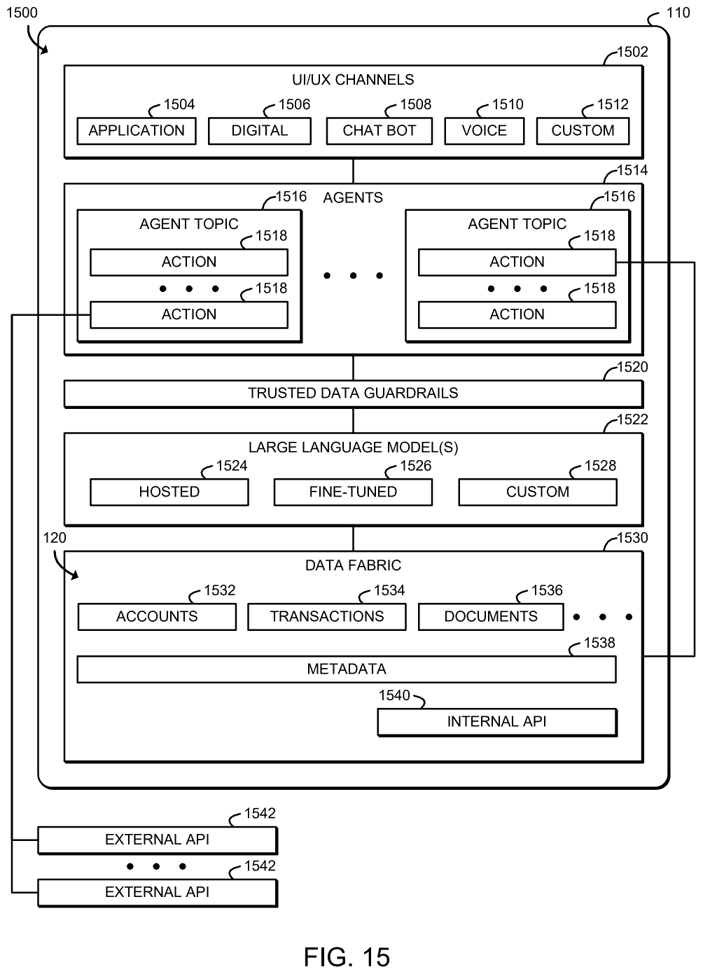

Referring now to FIG. 15, in an illustrative embodiment, the dispute resolution system 110 establishes an architecture 1500 during operation. The illustrative architecture 1500 includes multiple UI/UX channels 1502, agents 1514, trusted data guardrails 1520, large language models (LLMs) 1522, and a data fabric 1530. The various components of the architecture 1500 may be embodied as hardware, firmware, software, or a combination thereof. As such, in some embodiments, one or more of the components of the architecture 1500 may be embodied as circuitry or a collection of electrical devices (e.g., UI/UX channel circuitry 1502, agent circuitry 1514, trusted data guardrail circuitry 1520, LLM circuitry 1522, and/or data fabric circuitry 1530). It should be appreciated that, in such embodiments, one or more of those components may form a portion of the compute engine 210, the I/O subsystem 216, and/or other components of the dispute resolution system 110.

As shown, the architecture 1500 includes multiple UI/UX channels 1502. Each of those channels 1502 may include one or more user interaction modalities which allow a customer to interact with the dispute resolution system 110. As described further below, the user may perform dispute resolution using any combination of one or more of the channels 1502. In some embodiments, a particular dispute may be handled over a combination of multiple channels 1502. Accordingly, the channels 1502 may deliver a unified user experience to the customer over multiple channels 1502. In the illustrative embodiment, the channels 1502 include an application channel 1504, which may be embodied as a mobile application or other application; a digital channel 1506, which may be embodied as a website or other digital communication channel; a chat bot 1508, which may be embodied as a text-based messaging interface which in some embodiments may be incorporated in one or more other channels such as the application 1504 and/or the digital channel 1506 or may be use another messaging medium; a voice channel 1510, which may be embodied as an automated phone tree or other voice-based interface; and/or a customer channel 1512 which may incorporate features from one or more of the other channels 1502.

The architecture 1500 further includes multiple agents 1514. Each agent 1514 may be embodied as an autonomous entity that is empowered to perform tasks in a predetermined area of responsibility. As shown, the agents 1514 may be organized into multiple topics 1516, with each topic including one more potential actions 1516. Each action 1516 may be linked to a dispute resolution function, which may include calling one or more application programming interfaces (APIs). For example, as illustrated in FIG. 15, certain actions 1516 may call internal APIs 1540 (e.g., at the data fabric 1530), and certain actions 1516 may call external APIs 1542, which may be provide by third-party service providers, merchants, shipping companies, and/or other external entities.

The trusted data guardrails 1520 may be used to de-identify potentially sensitive data before it is handed to the LLMs 1522 for further processing. For example, in an embodiment, the guardrails 1520 may perform masking, tokenizing, or otherwise de-identify personally identifiable information (PII) before submitting the information to the LLMs 1522.

The LLMs 1522 may be embodied as one or more machine learning models configured for natural language processing. In the agentic architecture 1500, the LLMs 1522 may provide planning, reasoning, or other agent-related functions. For example, as described further below, the LLMs 1522 may be used to select among topics 1514 and actions 1516 of the agents 1512, and further may be used to prepare parameters for the selected actions 1516. In some embodiments, the LLMs 1522 may include one or more hosted LLMs 1524. The hosted LLMs 1524 may be embodied as one or more commercially available LLMs which may be hosted by one or more remote computing systems (e.g., cloud providers or other remote systems). Accordingly, because the hosted LLMs 1524 may be untrusted, in some embodiments all data passed to the hosted LLMs 1524 may be pre-processed by the trusted data guardrails 1520 prior to submission to the hosted LLM 1524. Each hosted LLM 1524 may be embodied as a general purpose model, foundation model, or other model trained on a large corpus of general information.

In some embodiments, the LLMs 1524 may include one or more fine-tuned LLMs 1526. Each fine-tuned LLM 1526 may be initially trained on a large, general corpus and then may be fine-tuned through training on a smaller corpus related to a particular dispute resolution function. For example, in some embodiments the fine-tuned LLM 1526 may be trained using historical data relating to disputed transactions and associated resolutions. As another example, the fine-tuned LLM 1526 may be further trained using one or more predetermined set of dispute resolution rules or regulations, such as government regulations for debit transactions (e.g., Regulation E, Electronic Fund Transfers, 12 CFR Part 1005), government regulations for credit transactions (e.g., Regulation Z, Truth in Lending, 12 CFR Part 1026), payment network dispute resolution rules (e.g., Visa or MasterCard dispute resolution rules), or other rules or regulations.

In some embodiments, the LLMs 1524 may include one or more custom LLMs 1528. Each custom LLM 1528 may be trained on a custom training data set including data similar to the training data for fine-tuned LLMs 1526 (e.g., historical data relating to disputed transactions and associated resolutions; government regulations for debit transactions (e.g., Regulation E, Electronic Fund Transfers, 12 CFR Part 1005); government regulations for credit transactions (e.g., Regulation Z, Truth in Lending, 12 CFR Part 1026); payment network dispute resolution rules (e.g., Visa or MasterCard dispute resolution rules); or other training data. In some embodiments, the custom LLMs 1528 may be hosted locally or otherwise trusted by the dispute resolution system 110. Accordingly, in those embodiments, certain data may be passed to a trusted custom LLM 1528 without requiring processing by the trusted data guardrails 1520.

The LLM 1522 may be trained using, for example, a set of historical results for dispute resolution. The training data may illustratively be divided into an 80/20 data set, with 20% of the data items used for training, 40% used for testing, and 40% for actual runs. The training may be complete and the LLM 1522 may be ready for deployment when accuracy is above a predetermined threshold, such as 80%. Of course, in other embodiments different training data sets and/or training methodologies may be used. In some embodiments, the LLM 1522 may be re-trained and/or re-fine-tuned based on additional training data. For example, the LLM 1522 may be retrained based on evaluations of resolved disputes (e.g., when a resolution has been flagged as incorrect by a human reviewer). Additionally or alternatively, when the LLM 1522 passes a user interaction and/or dispute to a human agent, the LLM 1522 may be retrained based on the resolution actions performed by the human agent.

In some embodiments, the architecture 1500 may include multiple LLMs 1522 or other AI models. For example, in some embodiments the architecture 1500 may include multiple LLMs 1522 that are each specialized for a particular domain, for example through training and/or fine-tuning. Continuing that example, one model may be an expert in predicting the next best action in the agentic process described below. Another model may be an expert in a particular dispute resolution policy (e.g., applicable regulations, payment network dispute resolution rules, or other policies). Yet another model may be an expert in identifying when to hand off determinations to another model (or a human agent). Still yet another model may be an expert in sentiment analysis, for example to modify tone or otherwise react to detected customer emotion. The agentic process described further below may manage multiple LLMs 1522, for example by receiving output from a model and passing the output (potentially including additional instructions) to another model.

As shown, the architecture 1500 further includes the data fabric 1530, which may include account data 1532, transaction data 1534, documents 1536, metadata 1538, and/or other data processed by the architecture 1500. As shown, the data fabric 1530 may be embodied as or otherwise include the databases 120 maintained by the dispute resolution system 110.

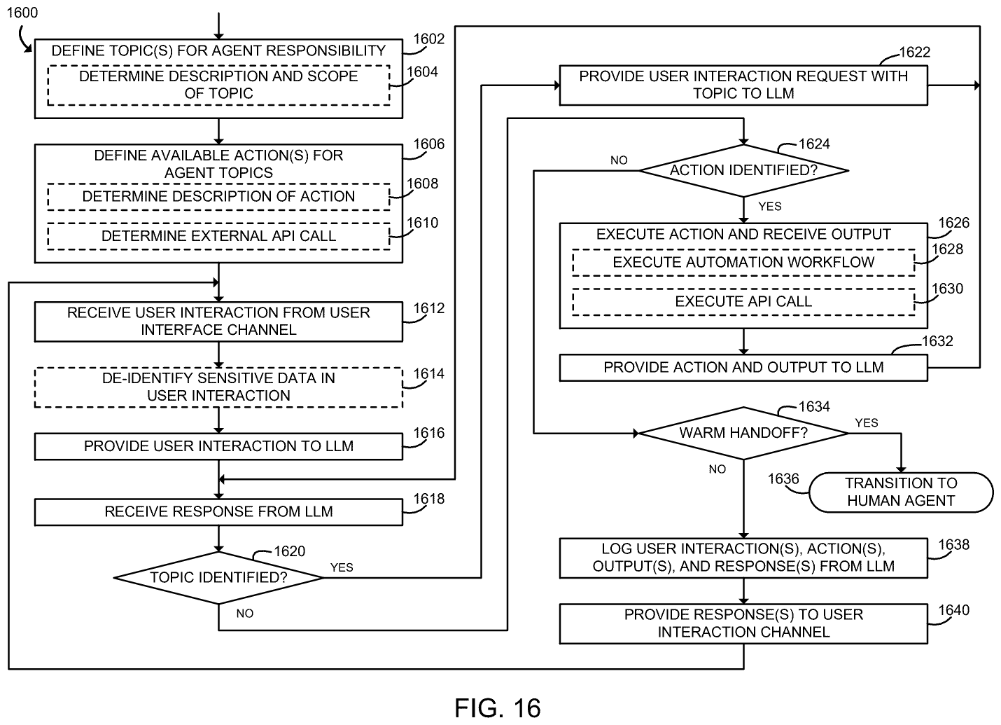

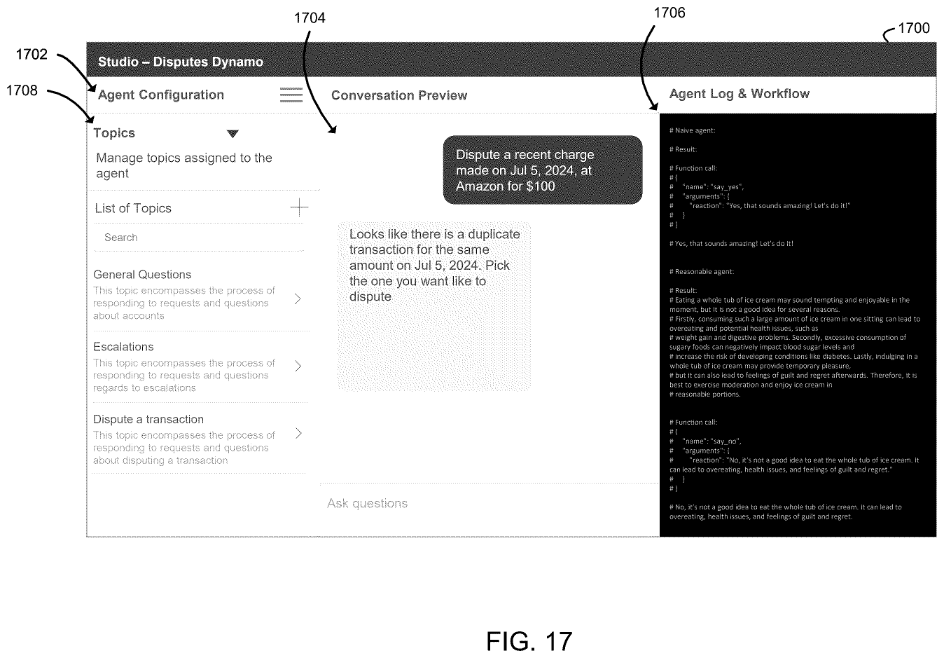

Referring now to FIG. 16, in use, the dispute resolution system 110 may execute a method 1600 for agentic dispute resolution. It should be appreciated that, in some embodiments, the operations of the method 1600 may be performed by one or more components of the architecture 1500 of the dispute resolution system 110 as shown in FIG. 15. The method 1600 begins with block 1602, in which the dispute resolution system 110 defines one or more topics 1516 for agent responsibility. Each of the topics 1516 may be defined by one or more natural language descriptions of the agent responsibility. As described below in connection with FIGS. 17-20, the topic 1516 definition may be provided with a no-code or low-code development user interface provided by the dispute resolution system 110. In some embodiments, in block 1604 the dispute resolution system 110 may determine a description and a scope for each topic 1516. Each of the description and the scope may be embodied as natural language data used to define the associated topic 1516, and may be provided by a user.

In block 1606, the dispute resolution system 110 defines one or more available actions 1518 for each of the agent topics 1516. Similar to the topics 1516, each of the actions 1518 may be defined by one or more natural language descriptions of the particular action 1518, including the goal or effect of the action, along with input parameters, outputs, and associated data formats. As described below in connection with FIGS. 17-20, the action 1518 definition may be provided with the no-code or low-code development user interface provided by the dispute resolution system 110. In some embodiments, in block 1608 the dispute resolution system 110 may determine a description of each action 1518, which may be embodied as natural language data used to define the associated action 1518. In some embodiments, in block 1610 the dispute resolution system 110 may determine an external API call for the action 1518. The external API call may be defined by a natural language description of the call, along with associated parameters and outputs. For example, the description may identify particular parameters and an associated format (e.g., JSON, XML, or another format) in a natural language description. Additionally or alternatively, in some embodiments the external API call may be defined using structured data, such as web addresses, data definitions, or other specific information.

In block 1612, the dispute resolution system 110 receives a user interaction from a UI/UX channel 1502. For example, the dispute resolution system 110 may receive a text inquiry to a chatbot via a website, mobile application, messaging service, voice call, or other communication channel. As described further below, in some embodiments the channel 1502 may maintain an active conversation or other session in which the user may provide continuing interactions. In some embodiments, such user interaction sessions may be migrated between channels 1502. In some embodiments, a user interaction may be triggered automatically or semi-automatically by the dispute resolution system 110. For example, when a user logs into the dispute resolution system 110, collected historical data on that user may be provided as a user interaction, which may allow the dispute resolution system 110 to identify and/or perform one or more actions that are appropriate for the user.

In some embodiments, in block 1614, the dispute resolution system 110 may de-identify sensitive data in the user interaction. For example, the dispute resolution system 110 may mask, tokenize, or otherwise de-identify personally identifying information such as names, identification numbers, account numbers, or other potentially sensitive information.

In block 1616, the dispute resolution system 110 provides the user interaction to one or more of the LLMs 1522. The user interaction may be provided with one or more prompts, available topics 1516 and/or actions 1518, contextual data including previous interactions, data retrieved from the data fabric 1530, and/or other appropriate data. In response, the LLM 1522 may determine the next best action, which may include identifying the appropriate topic 1516, identifying an action 1518 for execution, determining that a human agent may be required for current request, generating a response to the customer in the channel 1502, or another appropriate action.

In block 1618, the dispute resolution system 110 receives a response from the LLM 1522. The response may be formatted as natural language data, structured data, or another data format. The response indicates the next best action that was determined by the LLM 1522, and may include further data such as particular parameters, generated responses, and/or other data. In block 1620, the dispute resolution system 110 processes the received response and determines whether a topic 1516 was identified. If not, the method 1600 branches to block 1624, described below. If a topic 1516 was identified, the method 1600 advances to block 1622, in which the dispute resolution system 110 provides the user interaction request with the determined topic 1516 to the LLM 1522. By providing the topic 1516, the LLM 1522 may select from available actions 1518 for that topic 1516. After providing the determined topic 1516 to the LLM 1522, the method 1600 loops back to block 1618 to receive a further response from the LLM 1522.

In block 1624, the dispute resolution system 110 further processes the response received from the LLM 1522 and determines whether an action 1518 has been identified. If not, the method 1600 branches to block 1634, described below. If an action 1518 has been identified, the method 1600 advances to block 1626, in which the dispute resolution system 110 executes the identified action 1518 and receives output from the action. The dispute resolution system 110 may execute an action defined in the response, and may extract one or more input parameters from the response. In some embodiments, in block 1628 the dispute resolution system 110 may execute an automation workflow. The automation workflow may identify one or more business workflows or other processes that may be performed with the data fabric 130 or otherwise. In some embodiments, in block 1630 the dispute resolution system 110 may execute an API call, which may be an internal or external API call. For example, the dispute resolution system 110 may access a URL, URI, or other web address using input data provided by the LLM 1522, which may be formatted in JSON or another format required by the API call.

In block 1632, the dispute resolution system 110 provides the determined action and the received output to the LLM 1522. By providing the action and output, the LLM 1522 may evaluate the output data in context and determine an appropriate next step. After providing the action and output to the LLM 1522, the method 1600 loops back to block 1618 to receive a further response from the LLM 1522.

In block 1634, the dispute resolution system 110 further processes the response received from the LLM 1522 and determines whether a warm handoff has been requested. The LLM 1522 may request a warm handoff when it has determined that it is not capable of handling the present user request. For example, the LLM 1522 may determine that no remaining appropriate action is available for handling the user request other than performing the warm handoff. As another example, in an embodiment, a confidence level associated with the response may be evaluated, and if the confidence level is low (e.g., below a predetermined threshold), it may be determined that the response may not be correct. In those circumstances, a human agent may be required to resolve the current dispute). By evaluating confidence and transitioning to a human agent, the dispute resolution system 110 may avoid hallucinations; that is, results generated by the LLM 1522 that do not appear true or factual. If a warm handoff is identified, the method 1600 branches to block 1636, in which the dispute transitions to a human agent. For example, the dispute resolution system 110 may provide contextual data regarding the dispute, such as a log of the user interactions captured in the UI/UX channels 1502 as describe below, to a human agent who is empowered to assist the user. After transitioning the dispute to a human agent, the method 1600 is completed. The human agent may resolve the dispute completely or partially. For example, in an embodiment, the human agent may resolve an issue with the dispute and then the method 1600 may be restarted to complete resolution of the dispute. As described above, in some embodiments, in response to a warm handoff, the interaction may be marked as unsuccessful, and after successful resolution by the human agent, the LLM(s) 1522 may be retrained with the successful resolution.

Referring again to block 1634, if a warm handoff is not identified, then in the illustrative embodiment the response from the LLM 1522 is ready to send to the user, and the method 1600 branches to block 1638. Of course, in other embodiments, the method 1600 may perform additional response processing before sending to the user.

In block 1638, the dispute resolution system 110 logs all user interaction(s), action(s), output(s), and response(s) received from the LLM 1552. Accordingly, the dispute resolution system 110 logs a complete record of processing the dispute, including requests from the user, determinations made by the LLM 1552, resolution actions performed, and all other steps taken in resolving the dispute. Accordingly, the dispute resolution system 110 may generate an auditable record of dispute resolution that is traceable, for example for reporting to regulators.

In block 1640, the dispute resolution system 110 provides one or more responses to the user via an appropriate UI/UX channel 1502. The response may include explanatory text generated by the LLMs 1522 and/or data generated or otherwise received by one or more actions 1518, including data retrieved from the data fabric 1530 and/or one or more external APIs. After providing the response to the user, the method 1600 loops back to block 1612, in which the dispute resolution system 110 may receive another user interaction from the user. Accordingly, the method 1600 may proceed to process user interactions until the dispute is resolved.

Referring now to FIGS. 17-20, in an embodiment the dispute resolution system 110 may provide a no-code or low-code development system that allows one or more users to configure operation of the dispute resolution system 110 by providing domain knowledge for dispute resolution to the agents 1514. In particular, one or more users may define the areas of responsibility and available dispute resolution actions for the agents 1514, for example by defining one or more topics 1516 and associated actions 1518 for the agents 1514. Illustratively, most parameters of the topics 1516 and actions 1518 may be described by the user with natural language, without requiring the use of computer code or other traditional programming techniques. The no-code development system may be provided, for example, through one or more web applications, native applications, and/or other user interfaces provided by the dispute resolution system 110. Users may access the no-code development system using dispute resolution system 110 remotely using one or more client devices or otherwise access the dispute resolution system 110.

As shown in FIGS. 17-19, the dispute resolution system 110 may provide a user interface 1700, also called a studio interface, for configuring the agents 1514. The interface 1700 includes an agent configuration pane 1702, a conversation preview pane 1704, and an agent log and workflow pane 1706. The configuration pane 1702 provides user controls for creating, deleting, modifying, and/or otherwise configuring various components of the agents 1704, including the topics 1516 and the actions 1518. The conversation preview pane 1704 provides a preview chatbot interface for the current configuration of the current agents 1514, and may be updated in response to user input using one or more LLMs 1522 in combination with the current configuration of the agents 1514. In some embodiments, the preview pane 1704 may be linked to testing data, live data, or another data source. The agent log and workflow pane 1706 may indicate the prompts, responses, actions, and/or other operations that may be performed by the current agents 1514. In some embodiments, the agent log and workflow pane 1706 may correspond to the chatbot activity shown in the preview pane 1704.

The agent configuration pane 1702 may include a selectable user interface for configuring topics 1516 and/or actions 1518 of the agents 1514. As illustratively shown in FIG. 17, the configuration pane 1702 includes a topics manager 1708, which allows the user to configure all of the topics 1516 of the agents 1514. As shown, a user may create a new topic 1516, search the existing topics 1516, and browse/select existing topics 1516. Of course, other operations (e.g., deleting a topic 1516, copying a topic 1516, etc.) may be possible in other embodiments. As shown, the illustrative agents 1514 include three defined topics: General Questions, Escalations, and Dispute a Transaction. Those topics may be provided by a user, and may cover the topics of responsibility that may be handled by the dispute resolution system 110. Of course, in other embodiments, the agents 1514 may include a different number and/or arrangement of topics 1516.

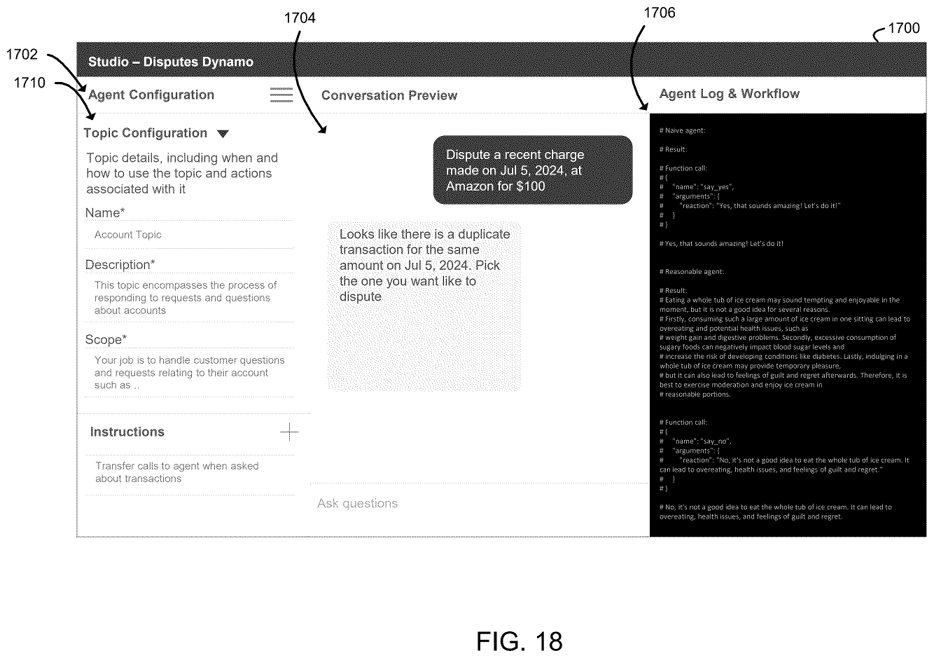

When a user selects a topic from the topics manager 1708, the configuration pane 1702 may change to a topic configurator 1710, shown in FIG. 18. The topic configurator 1710 allows the user to define features of the selected topic 1518. Each feature of the topic 1518 may include a natural language description provided by the user, which will be used, among other things, to prompt the LLM 1522 as described above. Illustratively, as shown in FIG. 18, each topic 1518 may be associated with a name, a description, a scope, and one or more instructions.

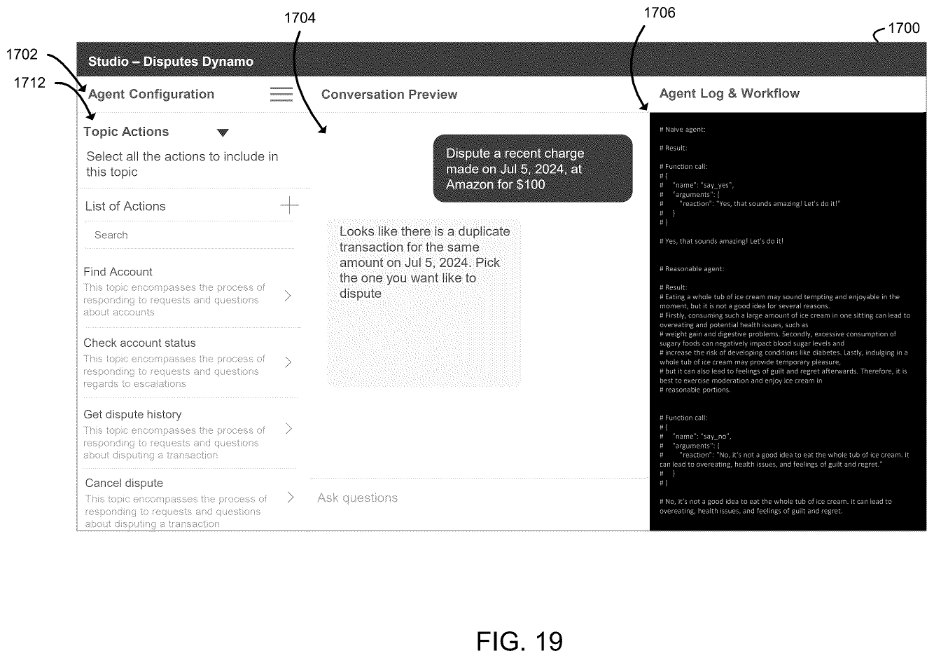

A user may also manage actions 1518 that are associated with a selected topic 1516. As shown in FIG. 19, the configuration pane 1702 may include an actions manager 1712, which allows the user to configure all of the actions 1518 associated with a topic 1516. As shown, a user may create a new action 1518, search the existing actions 1518, and browse/select existing actions 1518. Of course, other operations (e.g., deleting an topic 1518, copying an action 1518, etc.) may be possible in other embodiments. As shown, the illustrative actions 1518 for a topic 1516 include four defined actions: Find Account, Check Account Status, Get Dispute History, and Cancel Dispute. Those actions may be provided by a user, and may cover the actions that may be performed as part of a particular topic that may be handled by the dispute resolution system 110. Of course, in other embodiments, each topic 1516 may include a different number and/or arrangement of actions 1518.

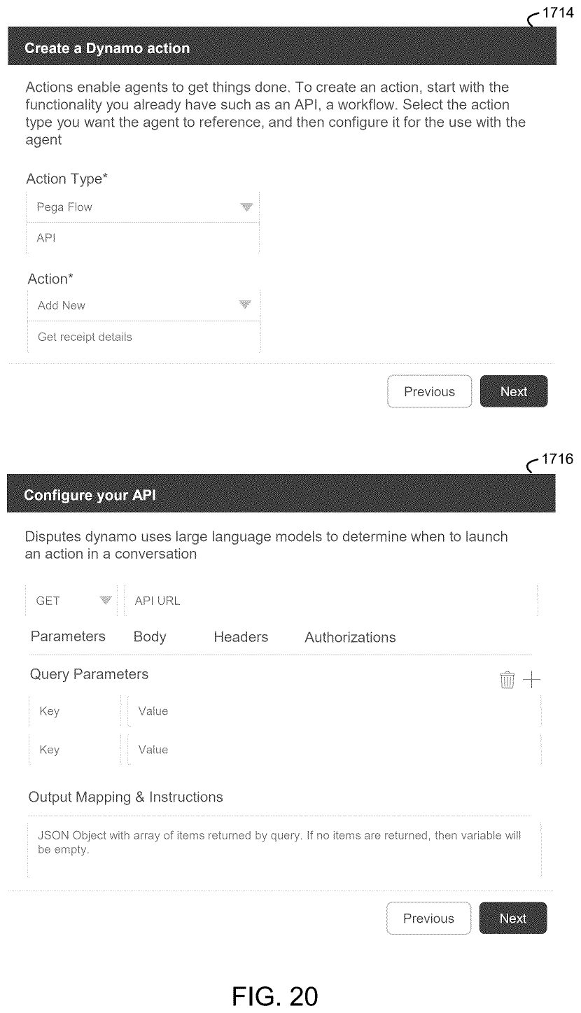

When a user selects an action 1518 from the actions manager 1712, the interface 1700 may display an action configurator user interface. Referring now to FIG. 20, in an illustrative embodiment, the action configurator user interface may be embodied as one or more modal user interfaces 1714, 1716, which may be presented in connection with the user interface 1700 or otherwise provided by the dispute resolution system 110. As shown, the user interface 1714 allows a user to define a new action 1518, including specifying the action type and an action description. The action type may specify that the action access a page flow or other predetermined automation workflow, or that the action accesses an application programming interface (API), which may be external or internal. The available automation workflows may be predetermined based on available automation workflows of the data fabric 1530 or otherwise preconfigured for the dispute resolution system 110. Details of each API call may be configured using the interface 1716, which allows a user to specify the API address and calling convention (e.g., HTTP GET, HTTP POST, etc.), query parameters, body, headers, authorization, and output mapping and instructions. The output mapping may include a natural language description of the requested output format for data returned by the API call. For example, the illustrative user interface requests that output from the API call is returned as a JSON object with an array of items returned from the query, and that is empty if no items are returned. In some embodiments, the LLM 1522 may configure output data based on the requested format. Accordingly, defining an action 1518 may include referencing one or more predetermined workflows or other APIs, which in turn may be defined using traditional programming languages or other coding techniques. However, once the actions 1518 are defined, they may be incorporated into agents 1514 and/or topics 1516 without additional coding.

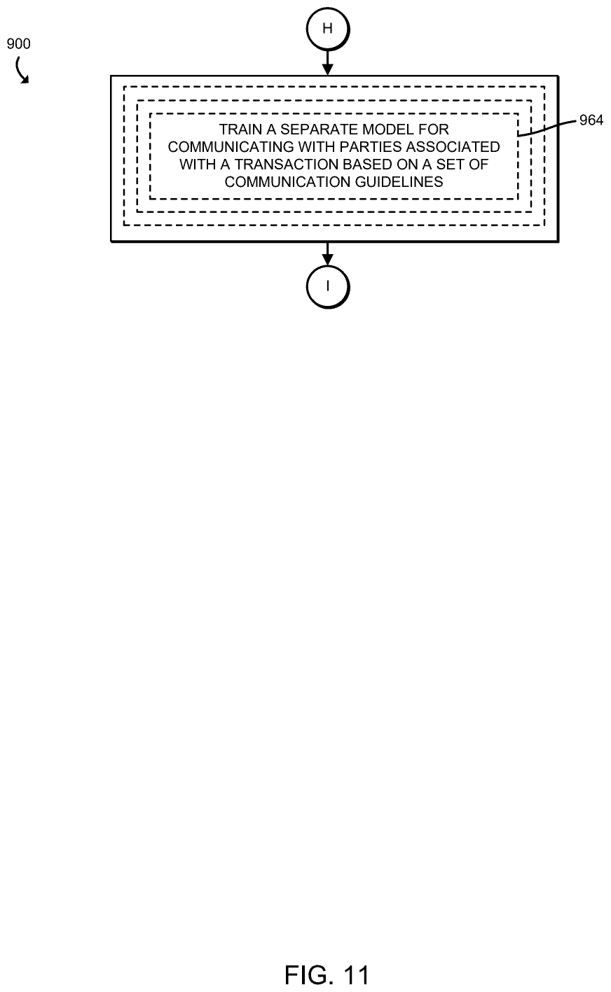

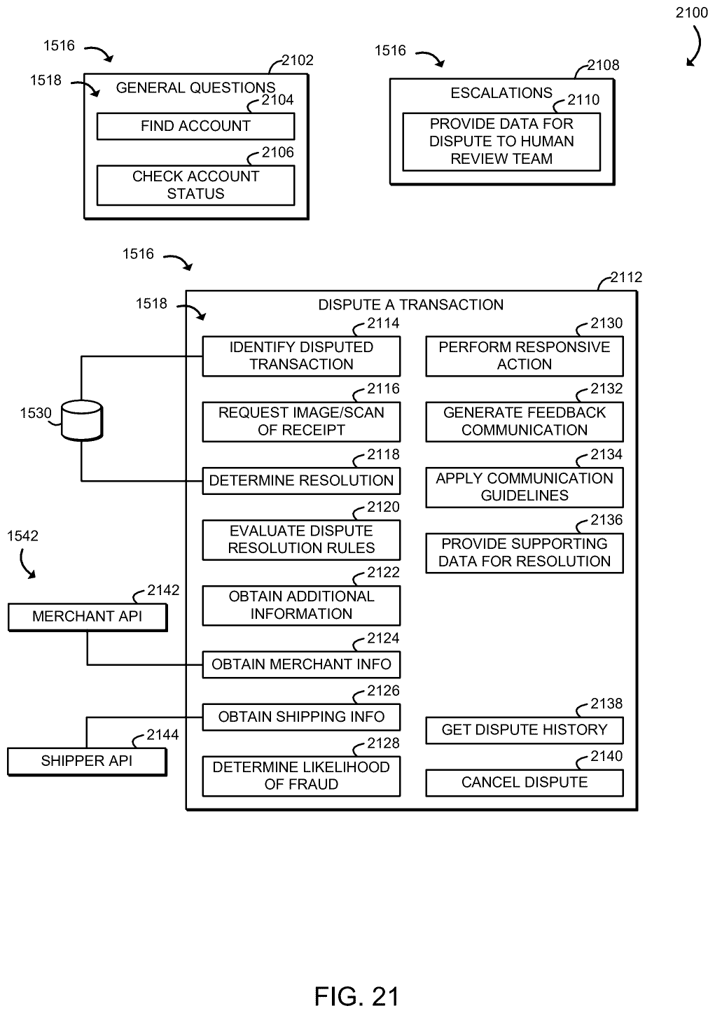

Referring now to FIG. 21, diagram 2100 illustrates at least one potential embodiment of an agentic system that may be developed using the no-code interface of FIGS. 17-20 and executed with the system and method of FIGS. 15-16. The illustrative agentic system is capable of autonomously resolving disputes in connection with financial transactions, similar to the system and methods described above in connection with FIGS. 3-14. In particular, the illustrative agentic system includes three topics 2102, 2108, 2112. The topic 2102 is described as general questions, and includes actions 2104, 2106. The action 2104 includes finding an account. The action 2104 may for example, identify an account based on account number, name, or other information provided by the user in the channel 1502. The action 2104 may perform additional actions to verify the identity of the user, including verifying user identity, verifying billing information, or other information. In an embodiment, one or more additional actions may be defined to perform account-related actions. For example, an action may be capable of handling a name change request, including requesting necessary supporting documents (e.g., marriage certificate, court order, etc.), performing optical character recognition on the received documents, and then acting on the resulting data, for example by updating account information in the data fabric 1530. The action 2106 includes checking an account status. The action 2106 may be invoked, for example, in response to a customer query regarding balance or other account status.

The topic 2108 is described as escalations, and includes action 2110. The action 2110 includes providing data for a dispute to a human agent for review. The LLM 1522 may select the action 2110 for invocation, for example, in circumstances where there is no other appropriate action 1518 available. As another example, the LLM 1522 may select the action 2110 for invocation when its confidence level is below a predetermined threshold, such as 80%. When the action 2110 is performed, the current user interaction session and/or current dispute may be passed to a human agent using a warm handoff as described above.

The topic 2112 is described as dispute a transaction, and includes actions 2114-2140. The action 2114 includes identifying a disputed transaction. The action 2114 may, for example, identify transactions based on date, amount, merchant, or other information provided by the user in the channel 1502. The action 2116 includes requesting images/scans of a receipt. The action 2116 may be invoked, for example, when a particular transaction is not identified based on other information provided by the user in the channel 1502. The action 2116 may include receiving the scanned receipt from the user, performing optical character recognition (OCR) on the scanned images, and provided the contents of the receipt to the LLM 1522. The action 2116 may perform OCR using, for example, one or more internal APIs 1540. Once the receipt contents are provided to the LLM 1522, the action 2114 may identify the disputed transaction based on contents of the receipt.

The action 2118 includes determining a resolution of a dispute. The dispute may be resolved by, for example, changing one or more customer transactions, changing balances, or performing other corrective actions determined by the LLMs 1522. The action 2118 may perform the resolution by, for example, invoking one or more internal APIs 1540 or otherwise modifying the data fabric 1530. The action 2118 may depend on results from other actions, such as finding an account 2104 and identifying a disputed transaction 2114.

For example, in an embodiment, the action 2118 may determine that a transaction is a duplicate of another transaction. In that example, the resolution may include declining or other reversing the duplicate transaction. Additionally or alternatively, in some embodiments the action 2118 may proactively identify a transaction as duplicate and prevent the duplicate transaction from proceeding (e.g., by preventing a duplicate charge from transitioning from “pending” to “posted”). Accordingly, the action 2118 may catch disputed transactions earlier, and in some cases before the user opens a dispute.

As described above, resolving a dispute with the action 2118 may include recursively calling the LLM 1522 with new prompts based on previous LLM 1522 determinations and/or results of actions 1518. For example, the action 2120 includes evaluating dispute resolution rules. In some embodiments, the action 2120 may evaluate a merchant's refund policy. For example, in some embodiments, the merchant's refund policy may be provided as a natural language description. In those embodiments, the refund policy may be passed to the LLM 1522 for evaluation, for example, as part of the prompt. Additionally or alternatively, in some embodiments the LLM 1522 may be trained and/or fine-tuned on the merchant's refund policy. Additionally or alternatively, in some embodiments, the merchant's refund policy may be defined by a merchant API 2142 or other programmatic interface. The action 2120 may determine, based on the merchant's policy (e.g., natural language, API, or other) whether a particular transaction can be refunded. In some embodiments, the action 2120 may determine a timeline for when a customer can expect a refund from the merchant, which may be generated based on historical performance of various merchants, the merchant's refund policy, and/or other information. The action 2120 may initiate a refund if appropriate, and the system 110 may generate an explanation for the user, for example using a generate feedback communication 2132 action as described below.

The action 2122 includes obtaining additional information. The action 2124 includes obtaining merchant information. The action 2126 includes obtaining shipping information. For example, a user interaction may indicate that the user paid for merchandise but has not received the merchandise. The action 2122 may identify additional information to request from the user, such as the particular product information and the merchant. For example, the action 2122 may request an image or other data from the user related to merchandise that was received. The action 2124 may obtain merchant information such as whether the item has shipped, tracking number, or other data, for example by accessing a merchant API 2142. The action 2124 may track the status of the merchandise if shipped, for example identifying the shipping company based on tracking number, determining an expected arrival date, or determining other shipping information, for example by accessing the shipper API 2144. Based on the determined additional information, dispute resolution actions may be determined. For example, if the merchandise has been shipped, shipping information may be displayed and the dispute may be placed on hold. As another example, if the merchandise has not been shipped, an inquiry may be made with the merchant concerning shipping dates, for example using the merchant API 2142. Continuing those examples, a timeline for resolution of the dispute may be determined based on merchant status and/or shipping status. When a dispute is on hold, in response to receiving an updated request or other interaction from the customer, the system 110 may check the timeline conditions and re-open the dispute for resolution.

The action 2128 includes determining a likelihood of fraud. For example, in an embodiment, the action 2128 may identify that a particular merchant is likely fraudulent. Continuing that example, in an embodiment the action 2128 may identify using the data fabric 1530 that a particular merchant has already been determined to be fraudulent in a previous dispute and has been placed on a “blacklist” of fraudulent merchants. Continuing that example, for a subsequent dispute involving a blacklisted merchant, the action 2128 may determine that the transaction is fraudulent, and then that transaction is declined (for example, by the perform responsive action 2130). Additionally or alternatively, in another embodiment the action 2128 may determine a score or other criteria for particular merchants that is indictive of the likelihood that a merchant is fraudulent. In some embodiments, the action 2128 may access external data, such as an API 1542 provided by a payment network or other external data source. Data indicative of whether a merchant is likely fraudulent may include transaction history for the merchant, and other data related to the merchant (e.g., website history, domain name history, etc.).

The action 2128 may use other techniques to determine the likelihood of fraud. For example, the action 2128 may determine and compare physical locations of the transaction (e.g., a brick and mortar store) and the cardholder, typical locations of the cardholder, time of purchase and time zone of cardholder, attributes of cardholder (e.g., gender, martial status, etc.) compared to merchandise, family members of cardholder, and/or other data. The action 2128 may generate requests for additional information, such as determining whether the user is in physical possession of the card, determining whether a family member of the user traveled to the location of the transaction, or other additional information.

The action 2130 includes performing a responsive action. The particular action 2130 performed may be determined or specified by the LLM 1522 after performing other actions 1518. For example, when a transaction is determined to be likely fraudulent by the action 2128, then the transaction may be declined. As another example, the action 2128 may determine that the customer's account is likely compromised, and then in the responsive action 2130 the customer's payment card may be closed, and a new payment card may be issued.

The action 2132 includes generating feedback communication. The action 2134 includes applying communication guidelines. The action 2136 includes providing supporting data for a resolution. The particular feedback communication generated may be determined based on outcomes of one or more other actions, including determining the resolution 2118 and/or performing the responsive action 2130. Applying the communication guidelines 2134 may include instructing the LLM 1522 with the communication guidelines 2134 when preparing feedback communications. Communication guidelines may include tone, frequency, content, and/or other specified aspects of the feedback communications. The communications guidelines may be provided to the LLM 1522, for example as part of the prompt, and/or may be used to train and/or fine-tune the LLM 1522.

The action 2138 includes getting a dispute history. For example, the action 2138 may identify an existing dispute and associated user communications, actions, and other data. The existing dispute may have occurred in a different channel 1502 and/or across multiple channels 1502. The action 2140 includes canceling a dispute. Canceling the dispute may be accomplished, for example, by invoking an internal API 1540. Those actions 2138, 2140 may depend on results from other actions, such as finding an account 2104 and identifying a disputed transaction 2114 or otherwise identifying the specified dispute. In response to canceling the dispute, further actions may be performed, including generating feedback communication 2132 and applying communication guidelines 2134.

As shown, one or more of the illustrative actions 1518 may access the data fabric 1530. For example, the illustrative actions 2114, 2118 may access the data fabric 1530, for example using one or more automation workflows. Similarly, one or more of the illustrative actions 1518 may access one or more internal APIs 1540 and/or external APIs 1542. For example, the obtain merchant information action 2124 may access a merchant API 2142, for example provided by a third-party ecommerce provider. As another example, the obtain shipping information action 2126 may access a shipper API 2144, for example provided by a shipping company. Although certain actions 1518 are illustrated as accessing the data fabric 1530 and/or APIs 1540, 1542, it should be understood that each action 1518 may access any other arrangement of data fabric 1530 and/or APIs 1540, 1542.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a system comprising circuitry configured to identify, from a set of financial transactions associated with a financial account, a financial transaction for a dispute; determine, using an artificial intelligence model trained on transaction dispute resolution rules of one or more payment networks, a resolution to the dispute; and perform, based on the determined resolution, a responsive action.

Example 2 includes the subject matter of Example 1, and wherein the circuitry is further configured to preprocess transaction data to satisfy formatting or data completeness rules.

Example 3 includes the subject matter of any of Examples 1 and 2, and wherein the circuitry is further configured to provide a graphical user interface, a text based user interface, or a voice based user interface.

Example 4 includes the subject matter of any of Examples 1-3, and wherein the circuitry is further configured to provide a user interface for a mobile application or website.

Example 5 includes the subject matter of any of Examples 1-4, and wherein to identify a financial transaction for a dispute comprises to present a list of transactions associated with an account of a customer; and receive a user selection of a transaction to dispute.

Example 6 includes the subject matter of any of Examples 1-5, and wherein to present a list of transactions comprises to present a list of credit card transactions or debit card transactions.

Example 7 includes the subject matter of any of Examples 1-6, and wherein to receive a user selection of a transaction to dispute comprises to receive a user selection of a transaction in the presented list of transactions.

Example 8 includes the subject matter of any of Examples 1-7, and wherein to receive a user selection comprises to receive a user selection based on a contextual menu operation presented to the user.

Example 9 includes the subject matter of any of Examples 1-8, and wherein to receive a user selection comprises to receive a user selection based on a detection that the user has swiped on a representation of a transaction in the list and selected a user interface element to dispute the transaction.

Example 10 includes the subject matter of any of Examples 1-9, and wherein to identify the financial transaction comprises to identify the financial transaction based on a description of a transaction from a user.

Example 11 includes the subject matter of any of Examples 1-10, and wherein to identify the financial transaction comprises to identify the financial transaction based on a description that identifies one or more of a date, time, or merchant associated with the financial transaction.

Example 12 includes the subject matter of any of Examples 1-11, and wherein the circuitry is further configured to identify a reason for the dispute.

Example 13 includes the subject matter of any of Examples 1-12, and wherein to identify the reason for the dispute comprises to determine, from the set of financial transactions associated with the financial account, whether the financial transaction is a duplicate of another financial transaction.

Example 14 includes the subject matter of any of Examples 1-13, and wherein to identify the reason for the dispute comprises to obtain information from a user indicative of the reason for the dispute.

Example 15 includes the subject matter of any of Examples 1-14, and wherein to determine a resolution comprises to determine a resolution using an artificial intelligence model that is additionally trained on government regulations pertaining to financial transaction disputes.

Example 16 includes the subject matter of any of Examples 1-15, and wherein to determine a resolution using an artificial intelligence model that is additionally trained on government regulations pertaining to financial transaction disputes comprises to determine a resolution using an artificial intelligence model that is additionally trained on government regulations pertaining to one or more of disputes for debit related transactions or credit related transactions.

Example 17 includes the subject matter of any of Examples 1-16, and wherein to determine a resolution to the dispute comprises to determine the resolution using an artificial intelligence model trained on one or more of Visa dispute resolution rules or MasterCard dispute resolution rules.

Example 18 includes the subject matter of any of Examples 1-17, and wherein to determine a resolution to the dispute comprises to determine the resolution using an artificial intelligence model trained on policies of one or more merchants pertaining to refunds or product exchanges.

Example 19 includes the subject matter of any of Examples 1-18, and wherein to determine the resolution comprises to determine the resolution using an artificial intelligence model that is additionally trained on a set of communication guidelines.

Example 20 includes the subject matter of any of Examples 1-19, and wherein the circuitry is further configured to obtain additional data to determine the resolution.

Example 21 includes the subject matter of any of Examples 1-20, and wherein to obtain additional data comprises to obtain evidence of a purchase from a merchant in association with the financial transaction.

Example 22 includes the subject matter of any of Examples 1-21, and wherein to obtain evidence of a purchase comprises to obtain data representing a receipt for the purchase.

Example 23 includes the subject matter of any of Examples 1-22, and wherein to obtain additional data comprises to obtain data identifying a product associated with the dispute.

Example 24 includes the subject matter of any of Examples 1-23, and wherein to obtain data identifying the product comprises to obtain data indicative of whether the product provided to a customer matches a product purchased by the customer.

Example 25 includes the subject matter of any of Examples 1-24, and wherein the circuitry is further configured to obtain data indicative of a condition of the product provided to the customer.

Example 26 includes the subject matter of any of Examples 1-25, and wherein to obtain additional data comprises to obtain data indicative of a shipping status of a purchased product associated with the dispute.

Example 27 includes the subject matter of any of Examples 1-26, and wherein to obtain data indicative of a shipping status comprises to obtain a tracking code; determine, based on a format of the tracking code, a corresponding shipping company; and obtain, using an application programming interface call, shipping status data from the shipping company based on the tracking code.

Example 28 includes the subject matter of any of Examples 1-27, and wherein the circuitry is further configured to obtain data indicative of a target date for the product to reach the customer.

Example 29 includes the subject matter of any of Examples 1-28, and wherein the circuitry is further configured to obtain data indicative of a target date for a return of the product to reach the merchant.

Example 30 includes the subject matter of any of Examples 1-29, and wherein the circuitry is further configured to determine a likelihood that the financial transaction is fraudulent.

Example 31 includes the subject matter of any of Examples 1-30, and wherein to determine a likelihood that the financial transaction is fraudulent comprises to determine the likelihood based on a pattern of purchases by the customer, demographic information about the customer, a typical location of the customer, a location of the merchant, one or more family members of the customer, or one or more follow up questions to the customer pertaining to possible sources of the financial transaction.

Example 32 includes the subject matter of any of Examples 1-31, and wherein the circuitry is further configured to determine a confidence in the resolution; and provide, in response to a determination that the confidence does not satisfy a defined threshold, data indicative of the dispute to at least one human for review.

Example 33 includes the subject matter of any of Examples 1-32, and wherein to perform a responsive action comprises to initiate a refund.

Example 34 includes the subject matter of any of Examples 1-33, and wherein to perform a responsive action comprises to initiate a product exchange.

Example 35 includes the subject matter of any of Examples 1-34, and wherein to perform a responsive action comprises to lock a payment card associated with the disputed transaction.

Example 36 includes the subject matter of any of Examples 1-35, and wherein to perform a responsive action comprises to deny the dispute.

Example 37 includes the subject matter of any of Examples 1-36, and wherein to perform a responsive action comprises to notify one or more parties of the responsive action.

Example 38 includes the subject matter of any of Examples 1-37, and wherein the circuitry is further configured to provide continual feedback based on communication guidelines.

Example 39 includes the subject matter of any of Examples 1-38, and wherein to provide continual feedback comprises to provide feedback indicative of a timeline associated with resolution of the dispute.

Example 40 includes the subject matter of any of Examples 1-39, and wherein to provide feedback indicative of a timeline comprises to provide feedback indicative of a timeline to receive a refund.

Example 41 includes the subject matter of any of Examples 1-40, and wherein to provide feedback indicative of a timeline to receive a refund comprises to provide the feedback based on one or more of a refund policy of the merchant, historical refund performance of the merchant, or a shipping status of the product.

Example 42 includes the subject matter of any of Examples 1-41, and wherein to provide feedback indicative of a timeline comprises to provide feedback over multiple stages of resolution of the dispute.

Example 43 includes the subject matter of any of Examples 1-42, and wherein to provide feedback over multiple stages of resolution of the dispute comprises to provide feedback that shipment was completed or that a refund was initiated by the merchant.

Example 44 includes the subject matter of any of Examples 1-43, and wherein the circuitry is further configured to provide data to one or more parties indicative of one or more recommended actions to take based on the determined resolution.

Example 45 includes the subject matter of any of Examples 1-44, and wherein the circuitry is further configured to produce data indicative of a basis for the determined resolution.

Example 46 includes the subject matter of any of Examples 1-45, and wherein to produce data indicative of a basis for the resolution comprises to produce data indicative of one or more of the transaction dispute resolution rules applied to determine the resolution.

Example 47 includes the subject matter of any of Examples 1-46, and wherein to produce data indicative of a basis for the resolution comprises to produce data indicative of a government regulation, a payment network dispute resolution rule, or a merchant refund policy applied to determine the resolution.

Example 48 includes the subject matter of any of Examples 1-47, and wherein to produce data indicative of a basis for the resolution comprises to produce data indicative of a reference financial transaction from training data used to train the artificial intelligence model.

Example 49 includes a method comprising identifying, by a dispute resolution system and from a set of financial transactions associated with a financial account, a financial transaction for a dispute; determining, by the dispute resolution system and using an artificial intelligence model trained on transaction dispute resolution rules of one or more payment networks, a resolution to the dispute; and performing, by the dispute resolution system and based on the determined resolution, a responsive action.

Example 50 includes the subject matter of Example 49, and further including preprocessing, by the dispute resolution system, transaction data to satisfy formatting or data completeness rules.

Example 51 includes the subject matter of any of Examples 49 and 50, and further including providing, by the dispute resolution system, a graphical user interface, a text based user interface, or a voice based user interface.

Example 52 includes the subject matter of any of Examples 49-51, and further including providing, by the dispute resolution system, a user interface for a mobile application or website.

Example 53 includes the subject matter of any of Examples 49-52, and wherein identifying a financial transaction for a dispute comprises presenting a list of transactions associated with an account of a customer; and receiving a user selection of a transaction to dispute.

Example 54 includes the subject matter of any of Examples 49-53, and wherein presenting a list of transactions comprises presenting a list of credit card transactions or debit card transactions.

Example 55 includes the subject matter of any of Examples 49-54, and wherein receiving a user selection of a transaction to dispute comprises receiving a user selection of a transaction in the presented list of transactions.

Example 56 includes the subject matter of any of Examples 49-55, and wherein receiving a user selection comprises receiving a user selection based on a contextual menu operation presented to the user.

Example 57 includes the subject matter of any of Examples 49-56, and wherein receiving a user selection comprises receiving a user selection based on a detection that the user has swiped on a representation of a transaction in the list and selected a user interface element to dispute the transaction.

Example 58 includes the subject matter of any of Examples 49-57, and wherein identifying the financial transaction comprises identifying the financial transaction based on a description of a transaction from a user.

Example 59 includes the subject matter of any of Examples 49-58, and wherein identifying the financial transaction comprises identifying the financial transaction based on a description that identifies one or more of a date, time, or merchant associated with the financial transaction.

Example 60 includes the subject matter of any of Examples 49-59, and further including identifying, by the dispute resolution system, a reason for the dispute.

Example 61 includes the subject matter of any of Examples 49-60, and wherein identifying the reason for the dispute comprises determining, from the set of financial transactions associated with the financial account, whether the financial transaction is a duplicate of another financial transaction.

Example 62 includes the subject matter of any of Examples 49-61, and wherein identifying the reason for the dispute comprises obtaining information from a user indicative of the reason for the dispute.

Example 63 includes the subject matter of any of Examples 49-62, and wherein determining a resolution comprises determining a resolution using an artificial intelligence model that is additionally trained on government regulations pertaining to financial transaction disputes.

Example 64 includes the subject matter of any of Examples 49-63, and wherein determining a resolution using an artificial intelligence model that is additionally trained on government regulations pertaining to financial transaction disputes comprises determining a resolution using an artificial intelligence model that is additionally trained on government regulations pertaining to one or more of disputes for debit related transactions or credit related transactions.

Example 65 includes the subject matter of any of Examples 49-64, and wherein determining a resolution to the dispute comprises determining the resolution using an artificial intelligence model trained on one or more of Visa dispute resolution rules or MasterCard dispute resolution rules.

Example 66 includes the subject matter of any of Examples 49-65, and wherein determining a resolution to the dispute comprises determining the resolution using an artificial intelligence model trained on policies of one or more merchants pertaining to refunds or product exchanges.

Example 67 includes the subject matter of any of Examples 49-66, and wherein determining the resolution comprises determining the resolution using an artificial intelligence model that is additionally trained on a set of communication guidelines.

Example 68 includes the subject matter of any of Examples 49-67, and further including obtaining, by the dispute resolution system, additional data to determine the resolution.

Example 69 includes the subject matter of any of Examples 49-68, and wherein obtaining additional data comprises obtaining evidence of a purchase from a merchant in association with the financial transaction.

Example 70 includes the subject matter of any of Examples 49-69, and wherein obtaining evidence of a purchase comprises obtaining data representing a receipt for the purchase.

Example 71 includes the subject matter of any of Examples 49-70, and wherein obtaining additional data comprises obtaining data identifying a product associated with the dispute.

Example 72 includes the subject matter of any of Examples 49-71, and wherein obtaining data identifying the product comprises obtaining data indicative of whether the product provided to a customer matches a product purchased by the customer.

Example 73 includes the subject matter of any of Examples 49-72, and further including obtaining, by the dispute resolution system, data indicative of a condition of the product provided to the customer.

Example 74 includes the subject matter of any of Examples 49-73, and wherein obtaining additional data comprises obtaining data indicative of a shipping status of a purchased product associated with the dispute.

Example 75 includes the subject matter of any of Examples 49-74, and wherein obtaining data indicative of a shipping status comprises obtaining a tracking code; determining, based on a format of the tracking code, a corresponding shipping company; and obtaining, using an application programming interface call, shipping status data from the shipping company based on the tracking code.

Example 76 includes the subject matter of any of Examples 49-75, and further including obtaining, by the dispute resolution system, data indicative of a target date for the product to reach the customer.

Example 77 includes the subject matter of any of Examples 49-76, and further including obtaining, by the dispute resolution system, data indicative of a target date for a return of the product to reach the merchant.

Example 78 includes the subject matter of any of Examples 49-77, and further including determining, by the dispute resolution system, a likelihood that the financial transaction is fraudulent.

Example 79 includes the subject matter of any of Examples 49-78, and wherein determining a likelihood that the financial transaction is fraudulent comprises determining the likelihood based on a pattern of purchases by the customer, demographic information about the customer, a typical location of the customer, a location of the merchant, one or more family members of the customer, or one or more follow up questions to the customer pertaining to possible sources of the financial transaction.

Example 80 includes the subject matter of any of Examples 49-79, and further including determining, by the dispute resolution system, a confidence in the resolution; and providing, by the dispute resolution system and in response to a determination that the confidence does not satisfy a defined threshold, data indicative of the dispute to at least one human for review.

Example 81 includes the subject matter of any of Examples 49-80, and wherein performing a responsive action comprises initiating a refund.

Example 82 includes the subject matter of any of Examples 49-81, and wherein performing a responsive action comprises initiating a product exchange.

Example 83 includes the subject matter of any of Examples 49-82, and wherein performing a responsive action comprises locking a payment card associated with the disputed transaction.

Example 84 includes the subject matter of any of Examples 49-83, and wherein performing a responsive action comprises denying the dispute.

Example 85 includes the subject matter of any of Examples 49-84, and wherein performing a responsive action comprises notifying one or more parties of the responsive action.

Example 86 includes the subject matter of any of Examples 49-85, and further including providing, by the dispute resolution system, continual feedback based on communication guidelines.

Example 87 includes the subject matter of any of Examples 49-86, and wherein providing continual feedback comprises providing feedback indicative of a timeline associated with resolution of the dispute.

Example 88 includes the subject matter of any of Examples 49-87, and wherein providing feedback indicative of a timeline comprises providing feedback indicative of a timeline to receive a refund.

Example 89 includes the subject matter of any of Examples 49-88, and wherein providing feedback indicative of a timeline to receive a refund comprises providing the feedback based on one or more of a refund policy of the merchant, historical refund performance of the merchant, or a shipping status of the product.

Example 90 includes the subject matter of any of Examples 49-89, and wherein providing feedback indicative of a timeline comprises providing feedback over multiple stages of resolution of the dispute.

Example 91 includes the subject matter of any of Examples 49-90, and wherein providing feedback over multiple stages of resolution of the dispute comprises providing feedback that shipment was completed or that a refund was initiated by the merchant.

Example 92 includes the subject matter of any of Examples 49-91, and further including providing, by the dispute resolution system, data to one or more parties indicative of one or more recommended actions to take based on the determined resolution.

Example 93 includes the subject matter of any of Examples 49-92, and further including producing, by the dispute resolution system, data indicative of a basis for the determined resolution.

Example 94 includes the subject matter of any of Examples 49-93, and wherein producing data indicative of a basis for the resolution comprises producing data indicative of one or more of the transaction dispute resolution rules applied to determine the resolution.

Example 95 includes the subject matter of any of Examples 49-94, and wherein producing data indicative of a basis for the resolution comprises producing data indicative of a government regulation, a payment network dispute resolution rule, or a merchant refund policy applied to determine the resolution.

Example 96 includes the subject matter of any of Examples 49-95, and wherein producing data indicative of a basis for the resolution comprises producing data indicative of a reference financial transaction from training data used to train the artificial intelligence model.

Example 97 includes one or more machine-readable storage media comprising a plurality of instructions stored thereon that, in response to being executed, cause a dispute resolution system to identify, from a set of financial transactions associated with a financial account, a financial transaction for a dispute; determine, using an artificial intelligence model trained on transaction dispute resolution rules of one or more payment networks, a resolution to the dispute; and perform, based on the determined resolution, a responsive action.

Example 98 includes the subject matter of Example 97, and wherein the instructions additionally cause the dispute resolution system to preprocess transaction data to satisfy formatting or data completeness rules.

Example 99 includes the subject matter of any of Examples 97 and 98, and wherein the instructions additionally cause the dispute resolution system to provide a graphical user interface, a text based user interface, or a voice based user interface.

Example 100 includes the subject matter of any of Examples 97-99, and wherein the instructions additionally cause the dispute resolution system to provide a user interface for a mobile application or website.

Example 101 includes the subject matter of any of Examples 97-100, and wherein to identify a financial transaction for a dispute comprises to present a list of transactions associated with an account of a customer; and receive a user selection of a transaction to dispute.

Example 102 includes the subject matter of any of Examples 97-101, and wherein to present a list of transactions comprises to present a list of credit card transactions or debit card transactions.

Example 103 includes the subject matter of any of Examples 97-102, and wherein to receive a user selection of a transaction to dispute comprises to receive a user selection of a transaction in the presented list of transactions.

Example 104 includes the subject matter of any of Examples 97-103, and wherein to receive a user selection comprises to receive a user selection based on a contextual menu operation presented to the user.

Example 105 includes the subject matter of any of Examples 97-104, and wherein to receive a user selection comprises to receive a user selection based on a detection that the user has swiped on a representation of a transaction in the list and selected a user interface element to dispute the transaction.

Example 106 includes the subject matter of any of Examples 97-105, and wherein to identify the financial transaction comprises to identify the financial transaction based on a description of a transaction from a user.

Example 107 includes the subject matter of any of Examples 97-106, and wherein to identify the financial transaction comprises to identify the financial transaction based on a description that identifies one or more of a date, time, or merchant associated with the financial transaction.

Example 108 includes the subject matter of any of Examples 97-107, and wherein the instructions additionally cause the dispute resolution system to identify a reason for the dispute.

Example 109 includes the subject matter of any of Examples 97-108, and wherein to identify the reason for the dispute comprises to determine, from the set of financial transactions associated with the financial account, whether the financial transaction is a duplicate of another financial transaction.

Example 110 includes the subject matter of any of Examples 97-109, and wherein to identify the reason for the dispute comprises to obtain information from a user indicative of the reason for the dispute.

Example 111 includes the subject matter of any of Examples 97-110, and wherein to determine a resolution comprises to determine a resolution using an artificial intelligence model that is additionally trained on government regulations pertaining to financial transaction disputes.

Example 112 includes the subject matter of any of Examples 97-111, and wherein to determine a resolution using an artificial intelligence model that is additionally trained on government regulations pertaining to financial transaction disputes comprises to determine a resolution using an artificial intelligence model that is additionally trained on government regulations pertaining to one or more of disputes for debit related transactions or credit related transactions.

Example 113 includes the subject matter of any of Examples 97-112, and wherein to determine a resolution to the dispute comprises to determine the resolution using an artificial intelligence model trained on one or more of Visa dispute resolution rules or MasterCard dispute resolution rules.

Example 114 includes the subject matter of any of Examples 97-113, and wherein to determine a resolution to the dispute comprises to determine the resolution using an artificial intelligence model trained on policies of one or more merchants pertaining to refunds or product exchanges.

Example 115 includes the subject matter of any of Examples 97-114, and wherein to determine the resolution comprises to determine the resolution using an artificial intelligence model that is additionally trained on a set of communication guidelines.

Example 116 includes the subject matter of any of Examples 97-115, and wherein the instructions additionally cause the dispute resolution system to obtain additional data to determine the resolution.

Example 117 includes the subject matter of any of Examples 97-116, and wherein to obtain additional data comprises to obtain evidence of a purchase from a merchant in association with the financial transaction.

Example 118 includes the subject matter of any of Examples 97-117, and wherein to obtain evidence of a purchase comprises to obtain data representing a receipt for the purchase.

Example 119 includes the subject matter of any of Examples 97-118, and wherein to obtain additional data comprises to obtain data identifying a product associated with the dispute.

Example 120 includes the subject matter of any of Examples 97-119, and wherein to obtain data identifying the product comprises to obtain data indicative of whether the product provided to a customer matches a product purchased by the customer.

Example 121 includes the subject matter of any of Examples 97-120, and wherein the instructions additionally cause the dispute resolution system to obtain data indicative of a condition of the product provided to the customer.

Example 122 includes the subject matter of any of Examples 97-121, and wherein to obtain additional data comprises to obtain data indicative of a shipping status of a purchased product associated with the dispute.

Example 123 includes the subject matter of any of Examples 97-122, and wherein to obtain data indicative of a shipping status comprises to obtain a tracking code; determine, based on a format of the tracking code, a corresponding shipping company; and obtain, using an application programming interface call, shipping status data from the shipping company based on the tracking code.

Example 124 includes the subject matter of any of Examples 97-123, and wherein the instructions additionally cause the dispute resolution system to obtain data indicative of a target date for the product to reach the customer.

Example 125 includes the subject matter of any of Examples 97-124, and wherein the instructions additionally cause the dispute resolution system to obtain data indicative of a target date for a return of the product to reach the merchant.

Example 126 includes the subject matter of any of Examples 97-125, and wherein the instructions additionally cause the dispute resolution system to determine a likelihood that the financial transaction is fraudulent.

Example 127 includes the subject matter of any of Examples 97-126, and wherein to determine a likelihood that the financial transaction is fraudulent comprises to determine the likelihood based on a pattern of purchases by the customer, demographic information about the customer, a typical location of the customer, a location of the merchant, one or more family members of the customer, or one or more follow up questions to the customer pertaining to possible sources of the financial transaction.

Example 128 includes the subject matter of any of Examples 97-127, and wherein the instructions additionally cause the dispute resolution system to determine a confidence in the resolution; and provide, in response to a determination that the confidence does not satisfy a defined threshold, data indicative of the dispute to at least one human for review.

Example 129 includes the subject matter of any of Examples 97-128, and wherein to perform a responsive action comprises to initiate a refund.

Example 130 includes the subject matter of any of Examples 97-129, and wherein to perform a responsive action comprises to initiate a product exchange.

Example 131 includes the subject matter of any of Examples 97-130, and wherein to perform a responsive action comprises to lock a payment card associated with the disputed transaction.

Example 132 includes the subject matter of any of Examples 97-131, and wherein to perform a responsive action comprises to deny the dispute.

Example 133 includes the subject matter of any of Examples 97-132, and wherein to perform a responsive action comprises to notify one or more parties of the responsive action.

Example 134 includes the subject matter of any of Examples 97-133, and wherein the instructions additionally cause the dispute resolution system to provide continual feedback based on communication guidelines.

Example 135 includes the subject matter of any of Examples 97-134, and wherein to provide continual feedback comprises to provide feedback indicative of a timeline associated with resolution of the dispute.

Example 136 includes the subject matter of any of Examples 97-135, and wherein to provide feedback indicative of a timeline comprises to provide feedback indicative of a timeline to receive a refund.

Example 137 includes the subject matter of any of Examples 97-136, and wherein to provide feedback indicative of a timeline to receive a refund comprises to provide the feedback based on one or more of a refund policy of the merchant, historical refund performance of the merchant, or a shipping status of the product.

Example 138 includes the subject matter of any of Examples 97-137, and wherein to provide feedback indicative of a timeline comprises to provide feedback over multiple stages of resolution of the dispute.

Example 139 includes the subject matter of any of Examples 97-138, and wherein to provide feedback over multiple stages of resolution of the dispute comprises to provide feedback that shipment was completed or that a refund was initiated by the merchant.

Example 140 includes the subject matter of any of Examples 97-139, and wherein the instructions additionally cause the dispute resolution system to provide data to one or more parties indicative of one or more recommended actions to take based on the determined resolution.

Example 141 includes the subject matter of any of Examples 97-140, and wherein the instructions additionally cause the dispute resolution system to produce data indicative of a basis for the determined resolution.

Example 142 includes the subject matter of any of Examples 97-141, and wherein to produce data indicative of a basis for the resolution comprises to produce data indicative of one or more of the transaction dispute resolution rules applied to determine the resolution.

Example 143 includes the subject matter of any of Examples 97-142, and wherein to produce data indicative of a basis for the resolution comprises to produce data indicative of a government regulation, a payment network dispute resolution rule, or a merchant refund policy applied to determine the resolution.

Example 144 includes the subject matter of any of Examples 97-143, and wherein to produce data indicative of a basis for the resolution comprises to produce data indicative of a reference financial transaction from training data used to train the artificial intelligence model.

Example 145 includes a system comprising circuitry configured to obtain training data indicative of payment network dispute resolution rules; preprocess the training data to satisfy one or more of a set of formatting rules or a set of data completeness rules; and train, using the training data, a machine learning model to predict a resolution to a dispute for a financial transaction.

Example 146 includes the subject matter of Example 145, and wherein to obtain training data comprises to obtain training data from historical financial transaction disputes and resolutions.

Example 147 includes the subject matter of any of Examples 145 and 146, and wherein to obtain training data comprises to obtain training data indicative of transaction parameters including a date, price, product, merchant, transaction type or payment network associated with each financial transaction.

Example 148 includes the subject matter of any of Examples 145-147, and wherein to obtain training data comprises to obtain training data indicative of a reason for each dispute and a basis for each resolution.

Example 149 includes the subject matter of any of Examples 145-148, and wherein to obtain training data comprises to obtain training data indicative of government regulations for financial transaction disputes.

Example 150 includes the subject matter of any of Examples 145-149, and wherein to obtain training data indicative of government regulations for financial transaction disputes comprises to obtain training data indicative of government regulations for one or more of debit transactions or credit transactions.

Example 151 includes the subject matter of any of Examples 145-150, and wherein to obtain training data indicative of payment network dispute resolution rules comprises to obtain training data indicative of Visa payment network dispute resolution rules or MasterCard payment network dispute resolution rules.

Example 152 includes the subject matter of any of Examples 145-151, and wherein to obtain training data comprises to obtain training data indicative of merchant specific refund or exchange policies.

Example 153 includes the subject matter of any of Examples 145-152, and wherein to obtain training data comprises to obtain training data indicative of communication guidelines.

Example 154 includes the subject matter of any of Examples 145-153, and wherein to train a machine learning model comprises to train the machine learning model utilizing supervised learning.

Example 155 includes the subject matter of any of Examples 145-154, and wherein to train a machine learning model comprises to train the machine learning model utilizing unsupervised learning.

Example 156 includes the subject matter of any of Examples 145-155, and wherein to train a machine learning model comprises to adjust weights of a large language model.

Example 157 includes the subject matter of any of Examples 145-156, and wherein to train a machine learning model comprises to train an ensemble of multiple machine learning models.

Example 158 includes the subject matter of any of Examples 145-157, and wherein to train an ensemble of multiple machine learning models comprises to train a separate machine learning model for each of multiple types of financial transactions including debit financial transactions and credit financial transactions.

Example 159 includes the subject matter of any of Examples 145-158, and wherein to train an ensemble of multiple machine learning models comprises to train a separate machine learning model for each of multiple sets of payment network dispute resolution rules.

Example 160 includes the subject matter of any of Examples 145-159, and wherein to train an ensemble of multiple machine learning models comprises to train a separate machine learning model for communicating with parties associated with a financial transaction based on a set of communication guidelines.

Example 161 includes a method comprising obtaining, by a compute device, training data indicative of payment network dispute resolution rules; preprocessing, by the compute device, the training data to satisfy one or more of a set of formatting rules or a set of data completeness rules; and training, by the compute device and using the training data, a machine learning model to predict a resolution to a dispute for a financial transaction.

Example 162 includes the subject matter of Example 161, and wherein obtaining training data comprises obtaining training data from historical financial transaction disputes and resolutions.

Example 163 includes the subject matter of any of Examples 161 and 162, and wherein obtaining training data comprises obtaining training data indicative of transaction parameters including a date, price, product, merchant, transaction type or payment network associated with each financial transaction.

Example 164 includes the subject matter of any of Examples 161-163, and wherein obtaining training data comprises obtaining training data indicative of a reason for each dispute and a basis for each resolution.

Example 165 includes the subject matter of any of Examples 161-164, and wherein obtaining training data comprises obtaining training data indicative of government regulations for financial transaction disputes.

Example 166 includes the subject matter of any of Examples 161-165, and wherein obtaining training data indicative of government regulations for financial transaction disputes comprises obtaining training data indicative of government regulations for one or more of debit transactions or credit transactions.

Example 167 includes the subject matter of any of Examples 161-166, and wherein obtaining training data indicative of payment network dispute resolution rules comprises obtaining training data indicative of Visa payment network dispute resolution rules or MasterCard payment network dispute resolution rules.

Example 168 includes the subject matter of any of Examples 161-167, and wherein obtaining training data comprises obtaining training data indicative of merchant specific refund or exchange policies.

Example 169 includes the subject matter of any of Examples 161-168, and wherein obtaining training data comprises obtaining training data indicative of communication guidelines.

Example 170 includes the subject matter of any of Examples 161-169, and wherein training a machine learning model comprises training the machine learning model utilizing supervised learning.

Example 171 includes the subject matter of any of Examples 161-170, and wherein training a machine learning model comprises training the machine learning model utilizing unsupervised learning.

Example 172 includes the subject matter of any of Examples 161-171, and wherein training a machine learning model comprises adjusting weights of a large language model.

Example 173 includes the subject matter of any of Examples 161-172, and wherein training a machine learning model comprises training an ensemble of multiple machine learning models.

Example 174 includes the subject matter of any of Examples 161-173, and wherein training an ensemble of multiple machine learning models comprises training a separate machine learning model for each of multiple types of financial transactions including debit financial transactions and credit financial transactions.

Example 175 includes the subject matter of any of Examples 161-174, and wherein training an ensemble of multiple machine learning models comprises training a separate machine learning model for each of multiple sets of payment network dispute resolution rules.

Example 176 includes the subject matter of any of Examples 161-175, and wherein training an ensemble of multiple machine learning models comprises training a separate machine learning model for communicating with parties associated with a financial transaction based on a set of communication guidelines.

Example 177 includes one or more machine-readable storage media comprising a plurality of instructions stored thereon that, in response to being executed, cause a dispute resolution system to obtain training data indicative of payment network dispute resolution rules; preprocess the training data to satisfy one or more of a set of formatting rules or a set of data completeness rules; and train, using the training data, a machine learning model to predict a resolution to a dispute for a financial transaction.

Example 178 includes the subject matter of Example 177, and wherein to obtain training data comprises to obtain training data from historical financial transaction disputes and resolutions.

Example 179 includes the subject matter of any of Examples 177 and 178, and wherein to obtain training data comprises to obtain training data indicative of transaction parameters including a date, price, product, merchant, transaction type or payment network associated with each financial transaction.

Example 180 includes the subject matter of any of Examples 177-179, and wherein to obtain training data comprises to obtain training data indicative of a reason for each dispute and a basis for each resolution.

Example 181 includes the subject matter of any of Examples 177-180, and wherein to obtain training data comprises to obtain training data indicative of government regulations for financial transaction disputes.

Example 182 includes the subject matter of any of Examples 177-181, and wherein to obtain training data indicative of government regulations for financial transaction disputes comprises to obtain training data indicative of government regulations for one or more of debit transactions or credit transactions.

Example 183 includes the subject matter of any of Examples 177-182, and wherein to obtain training data indicative of payment network dispute resolution rules comprises to obtain training data indicative of Visa payment network dispute resolution rules or MasterCard payment network dispute resolution rules.

Example 184 includes the subject matter of any of Examples 177-183, and wherein to obtain training data comprises to obtain training data indicative of merchant specific refund or exchange policies.

Example 185 includes the subject matter of any of Examples 177-184, and wherein to obtain training data comprises to obtain training data indicative of communication guidelines.

Example 186 includes the subject matter of any of Examples 177-185, and wherein to train a machine learning model comprises to train the machine learning model utilizing supervised learning.

Example 187 includes the subject matter of any of Examples 177-186, and wherein to train a machine learning model comprises to train the machine learning model utilizing unsupervised learning.

Example 188 includes the subject matter of any of Examples 177-187, and wherein to train a machine learning model comprises to adjust weights of a large language model.

Example 189 includes the subject matter of any of Examples 177-188, and wherein to train a machine learning model comprises to train an ensemble of multiple machine learning models.

Example 190 includes the subject matter of any of Examples 177-189, and wherein to train an ensemble of multiple machine learning models comprises to train a separate machine learning model for each of multiple types of financial transactions including debit financial transactions and credit financial transactions.

Example 191 includes the subject matter of any of Examples 177-190, and wherein to train an ensemble of multiple machine learning models comprises to train a separate machine learning model for each of multiple sets of payment network dispute resolution rules.

Example 192 includes the subject matter of any of Examples 177-191, and wherein to train an ensemble of multiple machine learning models comprises to train a separate machine learning model for communicating with parties associated with a financial transaction based on a set of communication guidelines.

Example 193 includes a system comprising circuitry configured to define a plurality of topics for agent responsibility, wherein the plurality of topics comprises a disputed transaction topic; define a plurality of available actions for each topic of the plurality of topics, wherein the plurality of available actions comprise a transaction identification action, a resolution determination action, and a responsive action; receive a user interaction from a user interface channel; provide the user interaction with the plurality of topics and the plurality of actions to a large language model; identify an action of the plurality of actions with a plurality of parameters in response to provision of the user interaction to the large language model, wherein the action is related to a dispute for a financial transaction; execute the action with the plurality of parameters; provide a response to the user interface channel in response to execution of the action; and log data indicative of the user interaction, the identified action, the parameters, and the response.

Example 194 includes the subject matter of Example 193, and wherein the user interface channel comprises a chat interface session, a mobile application, a website interface, or an email message.

Example 195 includes the subject matter of any of Examples 193 and 194, and wherein the circuitry is further configured to de-identify sensitive data of the user interaction; wherein to provide the user interaction to the large language model comprises to provide the user interaction to the large language model in response to de-identification of the sensitive data of the user interaction.

Example 196 includes the subject matter of any of Examples 193-195, and wherein to execute the action with the plurality of parameters comprises to execute an automation workflow.

Example 197 includes the subject matter of any of Examples 193-196, and wherein to execute the action with the plurality of parameters comprises to execute an external application programming interface (API).

Example 198 includes the subject matter of any of Examples 193-197, and wherein to execute the action with the plurality of parameters comprises to access a transaction data fabric.

Example 199 includes the subject matter of any of Examples 193-198, and wherein the large language model comprises a fine-tuned model trained on transaction data.

Example 200 includes the subject matter of any of Examples 193-199, and wherein the large language model comprises a remotely hosted model.

Example 201 includes the subject matter of any of Examples 193-200, and wherein the circuitry is further configured to:
identify a warm handoff action in response to providing the user interaction to the large language model;
provide the user interaction and supporting data to a human agent in response to identification of the warm handoff action; and
log the warm handoff action.

Example 202 includes the subject matter of any of Examples 193-201, and wherein to execute the action with the plurality of parameters comprises to execute the transaction identification action.

Example 203 includes the subject matter of any of Examples 193-202, and wherein to execute the transaction identification action comprises to identify the financial transaction based on information included in the user interaction and identified by the large language model.

Example 204 includes the subject matter of any of Examples 193-203, and wherein the information included in the user interaction comprises one or more of a date, time, or merchant associated with the financial transaction.

Example 205 includes the subject matter of any of Examples 193-204, and wherein to execute the action with the plurality of parameters comprises to execute the resolution determination action, wherein to execute the resolution determination action comprises to identify a reason for the dispute.

Example 206 includes the subject matter of any of Examples 193-205, and wherein to identify the reason for the dispute comprises to determine whether the financial transaction for the dispute is a duplicate of another financial transaction.

Example 207 includes the subject matter of any of Examples 193-206, and wherein to identify the reason for the dispute comprises to request information from the user that is indicative of the reason for the dispute.

Example 208 includes the subject matter of any of Examples 193-207, and wherein to execute the action with the plurality of parameters comprises to execute the resolution determination action based on government regulations pertaining to financial transaction disputes.

Example 209 includes the subject matter of any of Examples 193-208, and wherein the large language model is trained with the government regulations pertaining to financial transaction disputes.

Example 210 includes the subject matter of any of Examples 193-209, and wherein the large language model is trained with government regulations pertaining to one or more of disputes for debit related transactions or credit related transactions.

Example 211 includes the subject matter of any of Examples 193-210, and wherein to execute the action with the plurality of parameters comprises to execute the resolution determination action based on payment network rules relating to dispute resolution.

Example 212 includes the subject matter of any of Examples 193-211, and wherein the large language model is trained with the payment network rules relating to dispute resolution.

Example 213 includes the subject matter of any of Examples 193-212, and wherein to execute the action with the plurality of parameters comprises to execute the resolution determination action based on policies of one or more merchants pertaining to refunds or product exchanges.

Example 214 includes the subject matter of any of Examples 193-213, and wherein the large language model is trained with the policies of the one or more merchants pertaining to refunds or product exchanges.

Example 215 includes the subject matter of any of Examples 193-214, and wherein to execute the action with the plurality of parameters comprises to generate the response based on a set of communication guidelines.

Example 216 includes the subject matter of any of Examples 193-215, and wherein the large language model is trained with the set of communication guidelines.

Example 217 includes the subject matter of any of Examples 193-216, and wherein to generate the response comprises to provide continual feedback based on the communication guidelines.

Example 218 includes the subject matter of any of Examples 193-217, and wherein to provide the continual feedback comprises to provide feedback indicative of a timeline associated with resolution of the dispute.

Example 219 includes the subject matter of any of Examples 193-218, and wherein to provide feedback indicative of a timeline comprises providing feedback indicative of a timeline to receive a refund.

Example 220 includes the subject matter of any of Examples 193-219, and wherein to provide feedback indicative of a timeline to receive a refund comprises to provide the feedback based on one or more of a refund policy of the merchant, historical refund performance of the merchant, or a shipping status of the product.

Example 221 includes the subject matter of any of Examples 193-220, and wherein to provide feedback indicative of a timeline comprises to provide feedback over multiple stages of resolution of the dispute.

Example 222 includes the subject matter of any of Examples 193-221, and wherein to provide feedback indicative of a timeline comprises to provide feedback over multiple stages of resolution of the dispute.

Example 223 includes the subject matter of any of Examples 193-222, and wherein to provide feedback over multiple stages of resolution of the dispute comprises to provide feedback that shipment was completed or that a refund was initiated by the merchant.

Example 224 includes the subject matter of any of Examples 193-223, and wherein to execute the action with the plurality of parameters comprises to execute the resolution determination action, wherein to execute the resolution determination action comprises to obtain additional data to determine a resolution for the dispute.

Example 225 includes the subject matter of any of Examples 193-224, and wherein to obtain the additional data comprises to obtain evidence of a purchase from a merchant in association with the financial transaction.

Example 226 includes the subject matter of any of Examples 193-225, and wherein to obtain the evidence of the purchase comprises to obtain data representing a receipt for the purchase.

Example 227 includes the subject matter of any of Examples 193-226, and wherein to obtain the additional data comprises to obtain data identifying a product associated with the dispute.

Example 228 includes the subject matter of any of Examples 193-227, and wherein to obtain the data identifying the product comprises to obtain data indicative of whether the product provided to a customer matches a product purchased by the customer.

Example 229 includes the subject matter of any of Examples 193-228, and wherein to obtain the additional data further comprises to obtain data indicative of a condition of the product provided to the customer.

Example 230 includes the subject matter of any of Examples 193-229, and wherein to obtain the additional data comprises to obtain data indicative of a shipping status of a purchased product associated with the dispute.

Example 231 includes the subject matter of any of Examples 193-230, and wherein to obtain the data indicative of the shipping status comprises to:
obtain a tracking code associated with the purchased product; and
obtain the shipping status code by execution of an external application programming interface call with the tracking code.

Example 232 includes the subject matter of any of Examples 193-231, and wherein to obtain the data indicative of the shipping status further comprises to obtain data indicative of a target date for the product to reach the customer.

Example 233 includes the subject matter of any of Examples 193-232, and wherein to obtain the data indicative of the shipping status further comprises to obtain data indicative of a target date for a return of the product to reach the merchant.

Example 234 includes the subject matter of any of Examples 193-233, and wherein to execute the action with the plurality of parameters comprises to execute the resolution determination action, wherein to execute the resolution determination action comprises to determine a likelihood that the financial transaction is fraudulent.

Example 235 includes the subject matter of any of Examples 193-234, and wherein to determine a likelihood that the financial transaction is fraudulent comprises to determine a pattern of purchases by the customer, demographic information about the customer, a typical location of the customer, a location of the merchant, one or more family members of the customer, or one or more follow up questions to the customer pertaining to possible sources of the financial transaction.

Example 236 includes the subject matter of any of Examples 193-235, and wherein the large language model is trained with a plurality of fraudulent transactions.

Example 237 includes the subject matter of any of Examples 193-236, and wherein to execute the action with the plurality of parameters comprises to execute the responsive action.

Example 238 includes the subject matter of any of Examples 193-237, and wherein to execute the responsive action comprises to initiate a product exchange.

Example 239 includes the subject matter of any of Examples 193-238, and wherein to execute the responsive action comprises to lock a payment card associated with the disputed transaction.

Example 240 includes the subject matter of any of Examples 193-239, and wherein to execute the responsive action comprises to deny the dispute.

Example 241 includes the subject matter of any of Examples 193-240, and wherein to execute the responsive action comprises to notify one or more parties of the responsive action.

Example 242 includes the subject matter of any of Examples 193-241, and wherein the circuitry is further configured to:
present a no-code user interface to a first user; and
in response to presentation of the no-code user interface:
receive a first topic of the plurality of topics from the first user; and
receive a first action associated of the plurality of available actions for the first topic from the first user.

Example 243 includes the subject matter of any of Examples 193-242, and wherein the circuitry is further configured to receive, in response to the presentation of the no-code user interface, a first application programming interface call specified for the first action from the user.

Example 244 includes the subject matter of any of Examples 193-243, and wherein the circuitry is further configured to receive, in response to the presentation of the no-code user interface, a first automation workflow specified for the first action from the user.

Example 245 includes a method for agentic dispute resolution, the method comprising defining, by a computing device, a plurality of topics for agent responsibility, wherein the plurality of topics comprises a disputed transaction topic; defining, by the computing device, a plurality of available actions for each topic of the plurality of topics, wherein the plurality of available actions comprise a transaction identification action, a resolution determination action, and a responsive action; receiving, by the computing device, a user interaction from a user interface channel; providing, by the computing device, the user interaction with the plurality of topics and the plurality of actions to a large language model; identifying, by the computing device, an action of the plurality of actions with a plurality of parameters in response to providing the user interaction to the large language model, wherein the action is related to a dispute for a financial transaction; executing, by the computing device, the action with the plurality of parameters; providing, by the computing device, a response to the user interface channel in response to executing the action; and logging, by the computing device, log data indicative of the user interaction, the identified action, the parameters, and the response.

Example 246 includes the subject matter of Example 245, and wherein the user interface channel comprises a chat interface session, a mobile application, a website interface, or an email message.

Example 247 includes the subject matter of any of Examples 245 and 246, and further comprising de-identifying, by the computing device, sensitive data of the user interaction; wherein providing the user interaction to the large language model comprises providing the user interaction to the large language model in response to de-identifying the sensitive data of the user interaction.

Example 248 includes the subject matter of any of Examples 245-247, and wherein executing the action with the plurality of parameters comprises executing an automation workflow.

Example 249 includes the subject matter of any of Examples 245-248, and wherein executing the action with the plurality of parameters comprises executing an external application programming interface (API).

Example 250 includes the subject matter of any of Examples 245-249, and wherein executing the action with the plurality of parameters comprises accessing a transaction data fabric.

Example 251 includes the subject matter of any of Examples 245-250, and wherein the large language model comprises a fine-tuned model trained on transaction data.

Example 252 includes the subject matter of any of Examples 245-251, and wherein the large language model comprises a remotely hosted model.

Example 253 includes the subject matter of any of Examples 245-252, and further comprising identifying, by the computing device, a warm handoff action in response to providing the user interaction to the large language model; providing, by the computing device, the user interaction and supporting data to a human agent in response to identifying the warm handoff action; and logging, by the computing device, the warm handoff action.

Example 254 includes the subject matter of any of Examples 245-253, and wherein executing the action with the plurality of parameters comprises executing the transaction identification action.

Example 255 includes the subject matter of any of Examples 245-254, and wherein executing the transaction identification action comprises identifying the financial transaction based on information included in the user interaction and identified by the large language model.

Example 256 includes the subject matter of any of Examples 245-255, and wherein the information included in the user interaction comprises one or more of a date, time, or merchant associated with the financial transaction.

Example 257 includes the subject matter of any of Examples 245-256, and wherein executing the action with the plurality of parameters comprises executing the resolution determination action, wherein executing the resolution determination action comprises identifying a reason for the dispute.

Example 258 includes the subject matter of any of Examples 245-257, and wherein identifying the reason for the dispute comprises determining whether the financial transaction for the dispute is a duplicate of another financial transaction.

Example 259 includes the subject matter of any of Examples 245-258, and wherein identifying the reason for the dispute comprises requesting information from the user that is indicative of the reason for the dispute.

Example 260 includes the subject matter of any of Examples 245-259, and wherein executing the action with the plurality of parameters comprises executing the resolution determination action based on government regulations pertaining to financial transaction disputes.

Example 261 includes the subject matter of any of Examples 245-260, and wherein the large language model is trained with the government regulations pertaining to financial transaction disputes.

Example 262 includes the subject matter of any of Examples 245-261, and wherein the large language model is trained with government regulations pertaining to one or more of disputes for debit related transactions or credit related transactions.

Example 263 includes the subject matter of any of Examples 245-262, and wherein executing the action with the plurality of parameters comprises executing the resolution determination action based on payment network rules relating to dispute resolution.

Example 264 includes the subject matter of any of Examples 245-263, and wherein the large language model is trained with the payment network rules relating to dispute resolution.

Example 265 includes the subject matter of any of Examples 245-264, and wherein executing the action with the plurality of parameters comprises executing the resolution determination action based on policies of one or more merchants pertaining to refunds or product exchanges.

Example 266 includes the subject matter of any of Examples 245-265, and wherein the large language model is trained with the policies of the one or more merchants pertaining to refunds or product exchanges.

Example 267 includes the subject matter of any of Examples 245-266, and wherein executing the action with the plurality of parameters comprises generating the response based on a set of communication guidelines.

Example 268 includes the subject matter of any of Examples 245-267, and wherein the large language model is trained with the set of communication guidelines.

Example 269 includes the subject matter of any of Examples 245-268, and wherein generating the response comprises providing continual feedback based on the communication guidelines.

Example 270 includes the subject matter of any of Examples 245-269, and wherein providing the continual feedback comprises providing feedback indicative of a timeline associated with resolution of the dispute.

Example 271 includes the subject matter of any of Examples 245-270, and wherein providing feedback indicative of a timeline comprises providing feedback indicative of a timeline to receive a refund.

Example 272 includes the subject matter of any of Examples 245-271, and wherein providing feedback indicative of a timeline to receive a refund comprises providing the feedback based on one or more of a refund policy of the merchant, historical refund performance of the merchant, or a shipping status of the product.

Example 273 includes the subject matter of any of Examples 245-272, and wherein providing feedback indicative of a timeline comprises providing feedback over multiple stages of resolution of the dispute.

Example 274 includes the subject matter of any of Examples 245-273, and wherein providing feedback indicative of a timeline comprises providing feedback over multiple stages of resolution of the dispute.

Example 275 includes the subject matter of any of Examples 245-274, and wherein providing feedback over multiple stages of resolution of the dispute comprises providing feedback that shipment was completed or that a refund was initiated by the merchant.

Example 276 includes the subject matter of any of Examples 245-275, and wherein executing the action with the plurality of parameters comprises executing the resolution determination action, wherein executing the resolution determination action comprises obtaining additional data to determine a resolution for the dispute.

Example 277 includes the subject matter of any of Examples 245-276, and wherein obtaining the additional data comprises obtaining evidence of a purchase from a merchant in association with the financial transaction.

Example 278 includes the subject matter of any of Examples 245-277, and wherein obtaining the evidence of the purchase comprises obtaining data representing a receipt for the purchase.

Example 279 includes the subject matter of any of Examples 245-278, and wherein obtaining the additional data comprises obtaining data identifying a product associated with the dispute.

Example 280 includes the subject matter of any of Examples 245-279, and wherein obtaining the data identifying the product comprises obtaining data indicative of whether the product provided to a customer matches a product purchased by the customer.

Example 281 includes the subject matter of any of Examples 245-280, and wherein obtaining the additional data further comprises obtaining data indicative of a condition of the product provided to the customer.

Example 282 includes the subject matter of any of Examples 245-281, and wherein obtaining the additional data comprises obtaining data indicative of a shipping status of a purchased product associated with the dispute.

Example 283 includes the subject matter of any of Examples 282-282, and wherein obtaining the data indicative of the shipping status comprises obtaining a tracking code associated with the purchased product; and obtaining the shipping status code by executing an external application programming interface call with the tracking code.

Example 284 includes the subject matter of any of Examples 245-283, and wherein obtaining the data indicative of the shipping status further comprises obtaining data indicative of a target date for the product to reach the customer.

Example 285 includes the subject matter of any of Examples 245-284, and wherein obtaining the data indicative of the shipping status further comprises obtaining data indicative of a target date for a return of the product to reach the merchant.

Example 286 includes the subject matter of any of Examples 245-285, and wherein executing the action with the plurality of parameters comprises executing the resolution determination action, wherein executing the resolution determination action comprises determining a likelihood that the financial transaction is fraudulent.

Example 287 includes the subject matter of any of Examples 245-286, and wherein determining a likelihood that the financial transaction is fraudulent comprises determining a pattern of purchases by the customer, demographic information about the customer, a typical location of the customer, a location of the merchant, one or more family members of the customer, or one or more follow up questions to the customer pertaining to possible sources of the financial transaction.

Example 288 includes the subject matter of any of Examples 245-287, and wherein the large language model is trained with a plurality of fraudulent transactions.

Example 289 includes the subject matter of any of Examples 245-288, and wherein executing the action with the plurality of parameters comprises executing the responsive action.

Example 290 includes the subject matter of any of Examples 245-289, and wherein executing the responsive action comprises initiating a product exchange.

Example 291 includes the subject matter of any of Examples 245-290, and wherein executing the responsive action comprises locking a payment card associated with the disputed transaction.

Example 292 includes the subject matter of any of Examples 245-291, and wherein executing the responsive action comprises denying the dispute.

Example 293 includes the subject matter of any of Examples 245-292, and wherein executing the responsive action comprises notifying one or more parties of the responsive action.

Example 294 includes the subject matter of any of Examples 245-293, and further comprising presenting, by the computing device, a no-code user interface to a first user; and in response to presenting the no-code user interface: receiving, by the computing device, a first topic of the plurality of topics from the first user; and receiving, by the computing device, a first action associated of the plurality of available actions for the first topic from the first user.

Example 295 includes the subject matter of any of Examples 245-294, and further comprising receiving, by the computing device in response to presenting the no-code user interface, a first application programming interface call specified for the first action from the user.

Example 296 includes the subject matter of any of Examples 245-295, and further comprising receiving, by the computing device in response to presenting the no-code user interface, a first automation workflow specified for the first action from the user.

Example 297 includes one or more machine-readable storage media comprising a plurality of instructions stored thereon that, in response to being executed, cause a dispute resolution system to define a plurality of topics for agent responsibility, wherein the plurality of topics comprises a disputed transaction topic; define a plurality of available actions for each topic of the plurality of topics, wherein the plurality of available actions comprise a transaction identification action, a resolution determination action, and a responsive action; receive a user interaction from a user interface channel; provide the user interaction with the plurality of topics and the plurality of actions to a large language model; identify an action of the plurality of actions with a plurality of parameters in response to provision of the user interaction to the large language model, wherein the action is related to a dispute for a financial transaction; execute the action with the plurality of parameters; provide a response to the user interface channel in response to execution of the action; and log data indicative of the user interaction, the identified action, the parameters, and the response.

Example 298 includes the subject matter of Example 297, and wherein the user interface channel comprises a chat interface session, a mobile application, a website interface, or an email message.

Example 299 includes the subject matter of any of Examples 297 and 298, and wherein the instructions additionally cause the dispute resolution system to: de-identify sensitive data of the user interaction; wherein to provide the user interaction to the large language model comprises to provide the user interaction to the large language model in response to de-identification of the sensitive data of the user interaction.

Example 300 includes the subject matter of any of Examples 297-299, and wherein to execute the action with the plurality of parameters comprises to execute an automation workflow.

Example 301 includes the subject matter of any of Examples 297-300, and wherein to execute the action with the plurality of parameters comprises to execute an external application programming interface (API).

Example 302 includes the subject matter of any of Examples 297-301, and wherein to execute the action with the plurality of parameters comprises to access a transaction data fabric.

Example 303 includes the subject matter of any of Examples 297-302, and wherein the large language model comprises a fine-tuned model trained on transaction data.

Example 304 includes the subject matter of any of Examples 297-303, and wherein the large language model comprises a remotely hosted model.

Example 305 includes the subject matter of any of Examples 297-304, and wherein the instructions additionally cause the dispute resolution system to identify a warm handoff action in response to providing the user interaction to the large language model; provide the user interaction and supporting data to a human agent in response to identification of the warm handoff action; and log the warm handoff action.

Example 306 includes the subject matter of any of Examples 297-305, and wherein to execute the action with the plurality of parameters comprises to execute the transaction identification action.

Example 307 includes the subject matter of any of Examples 297-306, and wherein to execute the transaction identification action comprises to identify the financial transaction based on information included in the user interaction and identified by the large language model.

Example 308 includes the subject matter of any of Examples 297-307, and wherein the information included in the user interaction comprises one or more of a date, time, or merchant associated with the financial transaction.

Example 309 includes the subject matter of any of Examples 297-308, and wherein to execute the action with the plurality of parameters comprises to execute the resolution determination action, wherein to execute the resolution determination action comprises to identify a reason for the dispute.

Example 310 includes the subject matter of any of Examples 297-309, and wherein to identify the reason for the dispute comprises to determine whether the financial transaction for the dispute is a duplicate of another financial transaction.

Example 311 includes the subject matter of any of Examples 297-310, and wherein to identify the reason for the dispute comprises to request information from the user that is indicative of the reason for the dispute.

Example 312 includes the subject matter of any of Examples 297-310, and wherein to execute the action with the plurality of parameters comprises to execute the resolution determination action based on government regulations pertaining to financial transaction disputes.

Example 313 includes the subject matter of any of Examples 297-312, and wherein the large language model is trained with the government regulations pertaining to financial transaction disputes.

Example 314 includes the subject matter of any of Examples 297-313, and wherein the large language model is trained with government regulations pertaining to one or more of disputes for debit related transactions or credit related transactions.

Example 315 includes the subject matter of any of Examples 297-314, and wherein to execute the action with the plurality of parameters comprises to execute the resolution determination action based on payment network rules relating to dispute resolution.

Example 316 includes the subject matter of any of Examples 297-315, and wherein the large language model is trained with the payment network rules relating to dispute resolution.

Example 317 includes the subject matter of any of Examples 297-316, and wherein to execute the action with the plurality of parameters comprises to execute the resolution determination action based on policies of one or more merchants pertaining to refunds or product exchanges.

Example 318 includes the subject matter of any of Examples 297-317, and wherein the large language model is trained with the policies of the one or more merchants pertaining to refunds or product exchanges.

Example 319 includes the subject matter of any of Examples 297-318, and wherein to execute the action with the plurality of parameters comprises to generate the response based on a set of communication guidelines.

Example 320 includes the subject matter of any of Examples 297-319, and wherein the large language model is trained with the set of communication guidelines.

Example 321 includes the subject matter of any of Examples 297-320, and wherein to generate the response comprises to provide continual feedback based on the communication guidelines.

Example 322 includes the subject matter of any of Examples 297-321, and wherein to provide the continual feedback comprises to provide feedback indicative of a timeline associated with resolution of the dispute.

Example 323 includes the subject matter of any of Examples 297-322, and wherein to provide feedback indicative of a timeline comprises providing feedback indicative of a timeline to receive a refund.

Example 324 includes the subject matter of any of Examples 297-323, and wherein to provide feedback indicative of a timeline to receive a refund comprises to provide the feedback based on one or more of a refund policy of the merchant, historical refund performance of the merchant, or a shipping status of the product.

Example 325 includes the subject matter of any of Examples 297-324, and wherein to provide feedback indicative of a timeline comprises to provide feedback over multiple stages of resolution of the dispute.

Example 326 includes the subject matter of any of Examples 297-325, and wherein to provide feedback indicative of a timeline comprises to provide feedback over multiple stages of resolution of the dispute.

Example 327 includes the subject matter of any of Examples 297-326, and wherein to provide feedback over multiple stages of resolution of the dispute comprises to provide feedback that shipment was completed or that a refund was initiated by the merchant.

Example 328 includes the subject matter of any of Examples 297-327, and wherein to execute the action with the plurality of parameters comprises to execute the resolution determination action, wherein to execute the resolution determination action comprises to obtain additional data to determine a resolution for the dispute.

Example 329 includes the subject matter of any of Examples 297-328, and wherein to obtain the additional data comprises to obtain evidence of a purchase from a merchant in association with the financial transaction.

Example 330 includes the subject matter of any of Examples 297-329, and wherein to obtain the evidence of the purchase comprises to obtain data representing a receipt for the purchase.

Example 331 includes the subject matter of any of Examples 297-330, and wherein to obtain the additional data comprises to obtain data identifying a product associated with the dispute.

Example 332 includes the subject matter of any of Examples 297-331, and wherein to obtain the data identifying the product comprises to obtain data indicative of whether the product provided to a customer matches a product purchased by the customer.

Example 333 includes the subject matter of any of Examples 297-332, and wherein to obtain the additional data further comprises to obtain data indicative of a condition of the product provided to the customer.

Example 334 includes the subject matter of any of Examples 297-328, and wherein to obtain the additional data comprises to obtain data indicative of a shipping status of a purchased product associated with the dispute.

Example 335 includes the subject matter of any of Examples 297-334, and wherein to obtain the data indicative of the shipping status comprises to obtain a tracking code associated with the purchased product; and obtain the shipping status code by execution of an external application programming interface call with the tracking code.

Example 336 includes the subject matter of any of Examples 297-335, and wherein to obtain the data indicative of the shipping status further comprises to obtain data indicative of a target date for the product to reach the customer.

Example 337 includes the subject matter of any of Examples 297-336, and wherein to obtain the data indicative of the shipping status further comprises to obtain data indicative of a target date for a return of the product to reach the merchant.

Example 338 includes the subject matter of any of Examples 297-337, and wherein to execute the action with the plurality of parameters comprises to execute the resolution determination action, wherein to execute the resolution determination action comprises to determine a likelihood that the financial transaction is fraudulent.

Example 339 includes the subject matter of any of Examples 297-338, and wherein to determine a likelihood that the financial transaction is fraudulent comprises to determine a pattern of purchases by the customer, demographic information about the customer, a typical location of the customer, a location of the merchant, one or more family members of the customer, or one or more follow up questions to the customer pertaining to possible sources of the financial transaction.

Example 340 includes the subject matter of any of Examples 297-339, and wherein the large language model is trained with a plurality of fraudulent transactions.

Example 341 includes the subject matter of any of Examples 297-340, and wherein to execute the action with the plurality of parameters comprises to execute the responsive action.

Example 342 includes the subject matter of any of Examples 297-341, and wherein to execute the responsive action comprises to initiate a product exchange.

Example 343 includes the subject matter of any of Examples 297-342, and wherein to execute the responsive action comprises to lock a payment card associated with the disputed transaction.

Example 344 includes the subject matter of any of Examples 297-343, and wherein to execute the responsive action comprises to deny the dispute.

Example 345 includes the subject matter of any of Examples 297-344, and wherein to execute the responsive action comprises to notify one or more parties of the responsive action.

Example 346 includes the subject matter of any of Examples 297-345, and wherein the instructions additionally cause the dispute resolution system to present a no-code user interface to a first user; and in response to presentation of the no-code user interface receive a first topic of the plurality of topics from the first user; and receive a first action associated of the plurality of available actions for the first topic from the first user.

Example 347 includes the subject matter of any of Examples 297-346, and wherein the instructions additionally cause the dispute resolution system to receive, in response to the presentation of the no-code user interface, a first application programming interface call specified for the first action from the user.

Example 348 includes the subject matter of any of Examples 297-347, and wherein the instructions additionally cause the dispute resolution system to receive, in response to the presentation of the no-code user interface, a first automation workflow specified for the first action from the user.

1. A system comprising:
circuitry configured to:
define a plurality of topics for agent responsibility, wherein the plurality of topics comprises a disputed transaction topic;
define a plurality of available actions for each topic of the plurality of topics, wherein the plurality of available actions comprise a transaction identification action, a resolution determination action, and a responsive action;
receive a user interaction from a user interface channel;
provide the user interaction with the plurality of topics and the plurality of actions to a large language model;
identify an action of the plurality of actions with a plurality of parameters in response to provision of the user interaction to the large language model, wherein the action is related to a dispute for a financial transaction;
execute the action with the plurality of parameters;
provide a response to the user interface channel in response to execution of the action; and
log data indicative of the user interaction, the identified action, the parameters, and the response.

2. The system of claim 1, wherein the user interface channel comprises a chat interface session, a mobile application, a website interface, or an email message.

3. The system of claim 1, wherein the circuitry is further configured to:
de-identify sensitive data of the user interaction;
wherein to provide the user interaction to the large language model comprises to provide the user interaction to the large language model in response to de-identification of the sensitive data of the user interaction.

4. The system of claim 1, wherein to execute the action with the plurality of parameters comprises to execute one or more of: (i) an automation workflow; and/or an external application programming interface (API).

5. The system of claim 1, wherein the large language model comprises: one or more of: (i) a fine-tuned model trained on transaction data; and/or a remotely hosted model.

6. The system of claim 5, wherein the circuitry is further configured to:
identify a warm handoff action in response to providing the user interaction to the large language model;
provide the user interaction and supporting data to a human agent in response to identification of the warm handoff action; and
log the warm handoff action.

7. The system of claim 1, wherein to execute the action with the plurality of parameters comprises to execute the transaction identification action by identifying the financial transaction based on information included in the user interaction and identified by the large language model.

8. The system of claim 7, wherein the information included in the user interaction comprises one or more of a date, time, or merchant associated with the financial transaction.

9. The system of claim 1, wherein to identify the reason for the dispute comprises: (i) to determine whether the financial transaction for the dispute is a duplicate of another financial transaction; (ii) to request information from the user that is indicative of the reason for the dispute.

10. The system of claim 1, wherein to execute the action with the plurality of parameters comprises to execute the resolution determination action based on policies of one or more merchants pertaining to refunds or product exchanges, wherein the large language model is trained with the policies of the one or more merchants pertaining to refunds or product exchanges.

11. The system of claim 1, wherein to execute the action with the plurality of parameters comprises to generate the response based on a set of communication guidelines.

12. The system of claim 11, wherein the large language model is trained with the set of communication guidelines.

13. The system of claim 11, wherein to generate the response comprises to provide continual feedback based on the communication guidelines.

14. The system of claim 13, wherein to provide the continual feedback comprises to provide feedback indicative of a timeline associated with resolution of the dispute.

15. The system of claim 14, wherein to provide feedback indicative of a timeline comprises providing feedback indicative of a timeline to receive a refund.

16. The system of claim 15, wherein to provide feedback indicative of a timeline to receive a refund comprises to provide the feedback based on one or more of a refund policy of the merchant, historical refund performance of the merchant, or a shipping status of the product.

17. The system of claim 14, wherein to provide feedback indicative of a timeline comprises to provide feedback over multiple stages of resolution of the dispute.

18. The system of claim 14, wherein to provide feedback indicative of a timeline comprises to provide feedback over multiple stages of resolution of the dispute.

19. The system of claim 18, wherein to provide feedback over multiple stages of resolution of the dispute comprises to provide feedback that shipment was completed or that a refund was initiated by the merchant.

20. The system of claim 1, wherein to execute the action with the plurality of parameters comprises to execute the resolution determination action, wherein to execute the resolution determination action comprises to obtain additional data to determine a resolution for the dispute.

21. The system of claim 20, wherein to obtain the additional data comprises to obtain evidence of a purchase from a merchant in association with the financial transaction.

22. The system of claim 21, wherein to obtain the evidence of the purchase comprises to obtain data representing a receipt for the purchase.

23. The system of claim 20, wherein to obtain the additional data comprises to obtain data identifying a product associated with the dispute.

24. The system of claim 23, wherein to obtain the data identifying the product comprises to obtain data indicative of whether the product provided to a customer matches a product purchased by the customer.

25. The system of claim 24, wherein to obtain the additional data further comprises to obtain data indicative of a condition of the product provided to the customer.

26. The system of claim 25, wherein to obtain the additional data comprises to obtain data indicative of a shipping status of a purchased product associated with the dispute.

27. The system of claim 26, wherein to obtain the data indicative of the shipping status comprises to:
obtain a tracking code associated with the purchased product; and
obtain the shipping status code by execution of an external application programming interface call with the tracking code.

28. The system of claim 26, wherein to obtain the data indicative of the shipping status further comprises to obtain data indicative of a target date for the product to reach the customer.

29. The system of claim 26, wherein to obtain the data indicative of the shipping status further comprises to obtain data indicative of a target date for a return of the product to reach the merchant.

30. The system of claim 29, wherein to execute the action with the plurality of parameters comprises to execute the resolution determination action, wherein to execute the resolution determination action comprises to determine a likelihood that the financial transaction is fraudulent.

31. The system of claim 30, wherein to determine a likelihood that the financial transaction is fraudulent comprises to determine a pattern of purchases by the customer, demographic information about the customer, a typical location of the customer, a location of the merchant, one or more family members of the customer, or one or more follow up questions to the customer pertaining to possible sources of the financial transaction.

32. The system of claim 30, wherein the large language model is trained with a plurality of fraudulent transactions.

33. The system of claim 1, wherein the circuitry is further configured to:
present a no-code user interface to a first user; and
in response to presentation of the no-code user interface:
receive a first topic of the plurality of topics from the first user; and
receive a first action associated of the plurality of available actions for the first topic from the first user.

34. The system of claim 33, wherein the circuitry is further configured to receive, in response to the presentation of the no-code user interface, a first application programming interface call specified for the first action from the user.

35. The system of claim 33, wherein the circuitry is further configured to receive, in response to the presentation of the no-code user interface, a first automation workflow specified for the first action from the user.
